(19) United States
(12) Patent Application Publication
(10) Pub. No.: US 2021/0192246 A1
(43) Pub. Date: Jun. 24, 2021

(54) CONVOLUTIONAL NEURAL NETWORK-BASED IMAGE PROCESSING METHOD AND DEVICE, AND UNMANNED AERIAL VEHICLE

(71) Applicant: SZ DJI TECHNOLOGY CO., LTD., Shenzhen (CN)

(72) Inventors: Kang YANG, Shenzhen (CN); Mingming GAO, Shenzhen (CN); Qian GU, Shenzhen (CN)

(21) Appl. No.: 17/190,378

(22) Filed: Mar. 2, 2021

Related U.S. Application Data
(63) Continuation of application No. PCT/CN2018/109190, filed on Sep. 30, 2018.

(51) Int. Cl. G06K 9/00; G06N 3/04; G06K 9/62

(52) U.S. Cl. CPC G06K 9/00979; G06K 9/6232; G06N 3/04

(57) ABSTRACT

Convolutional neural network-based image processing method and device are provided. The device includes a first on-chip memory and an arithmetic circuit configured to read a 3D feature map from a first on-chip memory by blocks the 3D feature map being divided into L blocks, perform processing of the current layer of the convolutional neural network on the 3D feature map by blocks; and store an output result of the current layer to the first on-chip memory. The first on-chip memory includes: S first storage spaces, each being used to store one of the L blocks included in the 3D feature map as input data of the current layer; and R second storage spaces, each being used to store output data of the current layer of one of the L blocks. L, S and R are integers greater than 1, and S and R are less than L.

### CROSS-REFERENCE TO RELATED APPLICATION

This application is a continuation of International Application No. PCT/CN2018/109190, filed on Sep. 30, 2018, the entire content of which is incorporated herein by reference.

### COPYRIGHT STATEMENT

The content disclosed in the patent document contains copyrighted materials. The copyright is owned by the copyright owner. The copyright owner does not object to anyone copying the official records and archives of the patent document or patent disclosure in the Patent and Trademark Office.

### FIELD OF THE DISCLOSURE

The present disclosure generally relates to the field of image processing, and, more particularly, relates to a convolutional neural network-based imaging processing method, and a convolutional neural network-based imaging processing device.

### BACKGROUND

Convolutional neural network (CNN) is an artificial neural network, which is widely used in image recognition and other fields. A typical CNN includes a convolutional layer, a pooling layer, an activation layer, and a fully connected layer, etc. A previous layer performs a corresponding computation according to input data, and outputs a computation result to a next layer. Initial input data undergoes multi-layer operations to obtain a final result.

In an existing CNN, after a corresponding computation is performed on each layer, a result is stored to an off-chip memory such as a double data rate (DDR) memory. A next layer reads an output result of a previous layer from the off-chip memory, stores the output result in the on-chip memory, and then performs a computation. The CNN requires many on-chip storage resources and strong processing capabilities.

Therefore, how to implement convolutional neural network computations is an urgent problem to be solved when processing capacity of a processing device is limited, or on-chip storage resources are limited.

### BRIEF SUMMARY OF THE DISCLOSURE

The present application provides a convolutional neural network-based imaging processing method and device, and an unmanned aerial vehicle (UAV). The method can realize computations of a convolutional neural network when processing capacity of a processing device is limited, or on-chip storage resources are limited. The method can save storage spaces and improve processing efficiency.

One aspect of the present application provides a convolutional neural network-based imaging processing method. The method includes: reading a 3D feature map from a first on-chip memory by blocks, the 3D feature map being divided into L blocks; performing processing of the current layer of the convolutional neural network on the 3D feature map by blocks; and storing an output result of the current layer to the first on-chip memory. The first on-chip memory includes S first storage spaces, each of the S first storage spaces is used to store one of the L blocks included in the 3D feature map as input data of a current layer of a convolutional neural network, and after the input data of the one of the L blocks stored on one of the first storage spaces has been read, another one of the L blocks is stored on the one of the first storage spaces. The first on-chip memory further includes R second storage spaces, each of the R second storage spaces is used to store output data of a current layer of one of the L blocks, and after the output data of the one of the L blocks stored in one of the second storage spaces has been read, output data of another one of the L blocks is stored on the one of the second storage spaces. The L, the S and the R are integers greater than or equal to 2, and the S and the R are less than the L.

Another aspect of the present application provides a convolutional neural network-based imaging processing device. The device includes a first on-chip memory and an arithmetic circuit. The arithmetic circuit is configured to: read a 3D feature map from a first on-chip memory by blocks, the 3D feature map being divided into L blocks; perform processing of the current layer of the convolutional neural network on the 3D feature map by blocks; and store an output result of the current layer to the first on-chip memory. The first on-chip memory includes S first storage spaces, each of the S first storage spaces is used to store one of the L blocks included in the 3D feature map as input data of a current layer of a convolutional neural network, and after the input data of the one of the L blocks stored on one of the first storage spaces has been read, another one of the L blocks is stored on the one of the first storage spaces. The first on-chip memory further includes R second storage spaces, each of the R second storage spaces is used to store output data of a current layer of one of the L blocks, and after the output data of the one of the L blocks stored in one of the second storage spaces has been read, output data of another one of the L blocks is stored on the one of the second storage spaces. The L, the S and the R are integers greater than or equal to 2, and the S and the R are less than the L.

Therefore, in embodiments of the present application, a 3D feature map is read from a first on-chip memory by blocks, a current layer of a convolutional neural network is processed on the 3D feature map by blocks, and an output result of the current layer is stored to the first on-chip memory. Processing by blocks requires small on-chip storage resources and low requirements on processing powers of arithmetic circuits and can process the 3D feature map when the on-chip storage resources or processing capacity are insufficient. And further, number of the blocks included in the 3D feature map is L, and the first on-chip memory includes S first storage spaces and R second storage spaces. S and R are less than L. Each first storage space is used to store input data of a current layer of a block. Each second storage space is used to store output data of a current layer of a block. After input data of one block stored in one of the first storage spaces is read, input data of another block is stored in the one of the first storage spaces. After input data of one block stored in one of the second storage spaces is read, input data of another block is stored in the one of the second storage spaces, thereby realizing reuse of storage spaces and saving storage spaces, Because S and R are greater than or equal to 2, processing pipelined work can be guaranteed, and processing efficiency can be improved.

### BRIEF DESCRIPTION OF THE DRAWINGS

In order to more clearly illustrate technical solutions in the embodiments of the present application, the following briefly introduces accompanying drawings that need to be used in a description of the embodiments. Obviously, the accompanying drawings in the following description are only some embodiments of the application. For those skilled in the art, other accompanying drawings can be obtained based on the accompanying drawings without creative efforts.

FIG. 1 illustrates a schematic diagram of architecture of a convolutional neural network consistent with various embodiments of the present application;

FIG. 2 illustrates a schematic diagram of a 3D feature map consistent with various embodiments of the present application;

FIG. 3 illustrates a schematic diagram of a pooling operation consistent with various embodiments of the present application;

FIG. 4 illustrates a system architecture diagram of a convolutional neural network system consistent with various embodiments of the present application;

FIG. 5 illustrates a schematic diagram of a convolutional neural network-based imaging processing method consistent with various embodiments of the present application;

FIG. 6 illustrates a schematic diagram of a 3D feature map division mode consistent with various embodiments of the present application;

FIG. 7 illustrates another schematic diagram of a 3D feature map division mode consistent with various embodiments of the present application;

FIG. 8 illustrates a schematic flow chart of a convolutional neural network-based imaging processing method consistent with various embodiments of the present application;

FIG. 9 illustrates a schematic diagram of a storage pipeline of storage spaces included in a first on-chip memory consistent with various embodiments of the present application;

FIG. 10 illustrates another schematic diagram of a storage pipeline of storage spaces included in a first on-chip memory consistent with various embodiments of the present application;

FIG. 11 illustrates a schematic diagram of a convolutional neural network-based imaging processing device consistent with various embodiments of the present application;

FIG. 12 illustrates another schematic diagram of a convolutional neural network-based imaging processing device consistent with various embodiments of the present application; and

FIG. 13 illustrates a schematic diagram of a UAV consistent with various embodiments of the present application.

### DETAILED DESCRIPTION

The following describe technical solutions in the embodiments of the present application with reference to the accompanying drawings in the embodiments of the present application. Obviously, the described embodiments are only part of the embodiments of the present application, rather than all the embodiments. Based on the embodiments in the present application, all other embodiments obtained by those skilled in the art without creative work shall fall within the protection scope of the present application.

Unless otherwise specified, all technical and scientific terms used in the embodiments of the present application have same meanings as commonly understood by those skilled in the art of the present application. The terms used in the present application is only for the purpose of describing specific embodiments and is not intended to limit the scope of the present application.

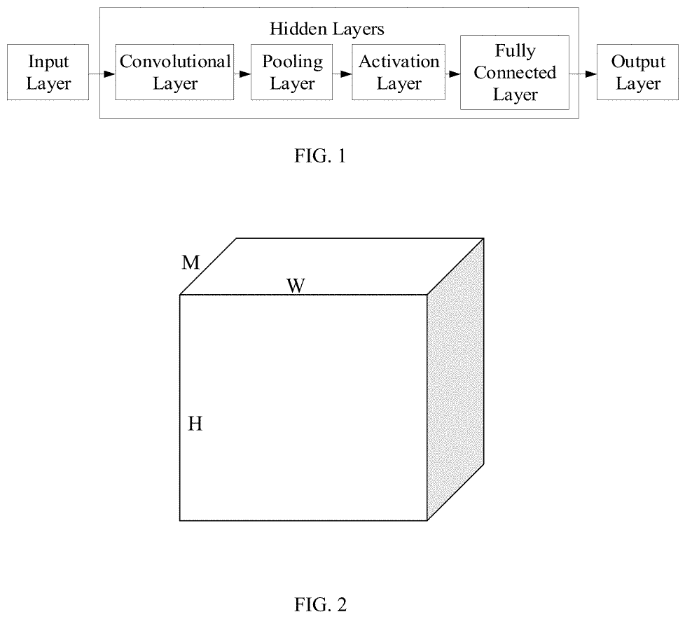

Convolutional neural network is an artificial neural network, which has a wide range of applications in image recognition and other fields. A convolutional neural network can include an input layer, hidden layers, and an output layer. The hidden layers may include a convolutional layer, a pooling layer, an activation layer, and a fully connected layer, etc., as shown in FIG. 1.

Each layer of the convolutional neural network can perform processing (e.g., convolution, pooling, activation or fully connected processing) on a feature map output by a current layer to obtain a feature map output by the current layer. The feature map in the embodiments of the present application may be a three-dimensional (3D) feature map. The 3D feature map can be referred to as a 3D feature matrix.

The 3D feature map can be understood as a stack of a plurality of two-dimensional (2D) feature maps. A 2D feature map can be referred to as a feature. Each 2D feature map can correspond to one channel of an image frame. The 3D feature map can be obtained from one image frame or from a plurality of image frames. When the 3D feature map obtained from an image frame, thickness of the 3D feature map (i.e., number of 2D feature maps) can be equal to number of channels of the image frame, such as R, G, and B channels. Channels can be called features, and number of channels can be regarded as number of features.

For example, as shown in FIG. 2, a size of the 3D feature map is W×H×M, where W represents width direction, H represents height direction, M represents channel direction (also called depth direction or thickness direction), and W×H represents a 2D feature map.

The features in the embodiments of the present application may also have other interpretations other than characterization of channels of an image frame, which is not limited in the embodiments of the present application.

Architecture of a convolutional neural network shown in FIG. 1 is only used for exemplary description. The convolutional neural network of the embodiments of the present application may also have other architectures. For example, the convolutional neural network does not include an activation layer, or the activation layer can be located before a pooling layer, etc.

In order to facilitate understanding, processing of each layer of a convolutional neural network is explained below.

Convolution operation of a convolution layer can output a 2D feature map after performing an operation using a convolution kernel (which can be a 3D convolution kernel, which can also be called a filter) and a 3D feature map. The operation can be an inner product operation for an eigenvalue of the 3D feature map and a weight of the convolution kernel. A plurality of convolution kernels can be used to respectively perform operations on the 3D feature map to obtain an output 3D feature map. Sizes of the plurality of convolution kernels can be same, but parameters can be different. Size of channel directions of the convolution kernel (i.e., number of features) may be same as size of the channel directions of the 3D feature map.

The convolution operation of the convolution layer can be carried out by sliding the convolution kernel. Taking an upper left corner of the 3D feature map as a starting point, the convolution kernel is slid to a lower right corner of the 3D feature map to generate a 2D feature map. After each sliding of the convolution kernel, the computing device extracts a 3D feature matrix with a same size as the convolution kernel from the 3D feature map and performs an inner product operation on the 3D feature matrix and the convolution kernel to generate an output feature value. After performing the above operations with a plurality of convolution kernels, a 3D feature map can be output.

Size of the 3D feature map output by the convolutional layer in a width direction can be

$$⌈ \frac{{w}_{0} + 2 {p}_{0} - {k}_{0}}{{s}_{0}} ⌉ + 1 .$$

w₀ represents size of the 3D feature map input to the convolution processing in the width direction, p₀ represents amount of data padded in the width direction of the 3D feature map during the convolution processing, k₀ represents size of the convolution kernel in the width direction of the convolution processing, s₀ represents stride of the convolution kernel sliding in the width direction.

Size of the 3D feature map output by the convolutional layer in a height direction can be

$$⌈ \frac{{H}_{0} + 2 {p}_{1} - {k}_{1}}{{s}_{1}} ⌉ + 1 .$$

H₀ represents size of the 3D feature map input to the convolution processing in the height direction, p₁ represents amount of data padded in the height direction of the 3D feature map during the convolution processing, k₁ represents size of the convolution kernel in the height direction of the convolution process, s₁ represents stride of the convolution kernel sliding in the height direction.

Size of the 3D feature map output by the convolutional layer in a channel direction may be equal to number of convolution kernels used.

Pooling operation of the pooling layer can also be called down-samples operation, whose purpose is to reduce feature mapping. When computing amount of the pooling operation is very large, a classifier with too many feature inputs is not easy to form but is easy to overfit. Since a feature after convolution is a static attribute, features of two different image regions are most likely the same. Therefore, when describing a large image, aggregate statistics can be used for different location features. Pooling can use a sliding window method, starting from an upper left corner of each feature of the input 3D feature map, according to a certain step length, sliding a window to a lower right corner of the feature in sequence to generate a 2D feature map. According to the above method, after sequentially generating 2D feature maps corresponding to all features, a 3D feature maps output by the pooling layer can be obtained. Commonly used operations for pooling generally include max pooling, mean pooling, Gaussian pooling, and trainable pooling.

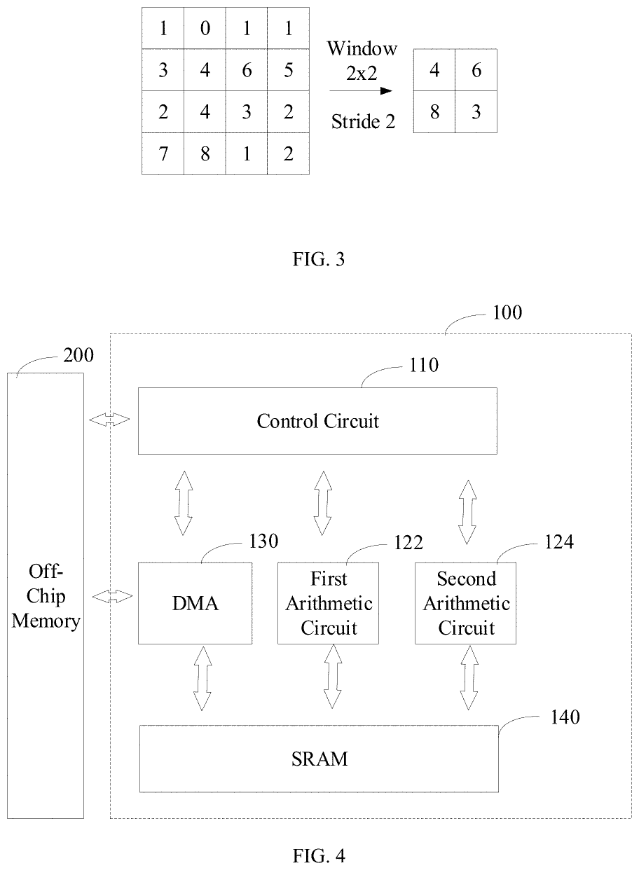

For example, as shown in FIG. 3, a pooling window is 2×2, and a stride is 2. Each maximum pooling operation can obtain a value respectively after operating on four numbers.

Size of the 3D feature map output by the pooling layer in a width direction can be

$$⌈ \frac{{w}_{1} + 2 {p}_{2} - {k}_{2}}{{s}_{2}} ⌉ + 1 .$$

w₁ represents size of the 3D feature map input to the convolution processing in the width direction, p₂ represents amount of data padded in the width direction of the 3D feature map during the convolution processing, k₂ represents size of the convolution kernel in the width direction of the convolution process, s₂ represents stride of the convolution kernel sliding in the width direction.

Size of the 3D feature map output by the convolutional layer in a height direction can be

$$⌈ \frac{{H}_{1} + 2 {p}_{3} - {k}_{3}}{{s}_{3}} ⌉ + 1 .$$

H₁ represents size of the 3D feature map input to the convolution processing in a height direction, p₃ represents amount of data padded in the height direction of the 3D feature map during the convolution processing, k₃ represents size of the convolution kernel in a height direction of the convolution process, s₃ represents stride of the convolution kernel sliding in a height direction.

Size of the 3D feature map output by the pooling layer in a channel direction can be equal to size of the 3D feature map input by the pooling layer in the channel direction, i.e., result of the pooling operation can keep number of features of the 3D feature map unchanged.

In an activation operation of the activation layer, for the 3D feature map, a specific activation function can be used to perform point-to-point mapping to obtain an output 3D feature map of the activation layer.

In CNN, after the input 3D feature map passes through the convolutional layer, the pooling layer, the activation layer, and enters the fully connected layer. The 3D feature map can be mapped into a long input vector and enter an output layer.

The operation of each layer described above are only one available implementation manner, which is only used for a better understanding of the present application. Operation of each layer may also have other implementation manners. For the sake of brevity, details are not described in the embodiments of the present application.

Processing of the convolutional neural network may be implemented by a processor such as a field programmable gate array (FPGA) or an application specific integrated circuit (ASIC), which are not limited in the embodiments of the present application.

With reference to FIG. 4, the following describes a system architecture diagram for implementing a convolutional neural network in one embodiment of the present application. The system for implementing the convolutional neural network may include a processor 100 and an off-chip memory 200. The processor 100 can be called an accelerator.

However, it should be understood that the embodiments of the present application are not limited thereto.

As shown in FIG. 4, the processor 100 may include a control circuit 110, a first arithmetic circuit 122, a second arithmetic circuit 124, a direct memory access (DMA) 130, and a static random-access memory (SRAM) 140 as an on-chip memory.

The control circuit 110 can control computations (e.g., size of computation data and timing of computations, etc.) of the first arithmetic circuit 122 and the second arithmetic circuit 124. Read time and read address of DMA 130 are controlled, so that DMA 130 can read data from the external memory 200 to SRAM 140 or write data from SRAM 140 to the external memory 200. The control circuit 110 can read instructions from the off-chip memory 200 for controlling the first arithmetic circuit 122, the second arithmetic circuit 124 and the DMA 130.

The first arithmetic circuit 122 and the second arithmetic circuit 124 can implement processing of the corresponding layers of the convolutional neural network. One arithmetic circuit can realize a computation of one layer. the computation of one layer can be realized by a plurality of arithmetic circuits in parallel. The first arithmetic circuit 122 and the second arithmetic circuit 124 can read data from the SRAM 140 to perform computations on the corresponding layers. A computation result can be output to SRAM 140 for storage. The first arithmetic circuit 122 and the second arithmetic circuit 124 may include an on-chip memory differentiated from SRAM for storing data in the first arithmetic circuit 122 and the second arithmetic circuit 124, such as intermediate results obtained by the first arithmetic circuit 122 and the second arithmetic circuit 124.

The DMA 130 can read data (e.g., data that can be used in computations of the first arithmetic circuit 122 and the second arithmetic circuit 124) from the off-chip memory 200 and store the data in the SRAM 140. Alternatively, data (e.g., the computation results output by the first arithmetic circuit 122 and the second arithmetic circuit 124) may be read from the SRAM 140, and the data may be stored to the off-chip memory 200.

The first arithmetic circuit 122 and the second arithmetic circuit 124 shown in FIG. 4 may perform processing of a same layer or different layers. The processor 100 may also include other numbers of arithmetic circuits, which are not specifically limited in the embodiments of the present application.

A system shown in FIG. 4 is only an implementation manner of the embodiments of the present application and should not constitute a special limitation to the embodiments of the present application.

In computations of a convolutional neural network, after each layer performs a corresponding computation, if an output result is stored to the off-chip memory, a next layer needs to read an output result of the previous layer from the off-chip memory. Therefore, the system needs to repeatedly read data from the off-chip memory and occupy system bandwidth.

Or, if an output result of the current layer is directly output to the next layer without occupying any storage space, an arithmetic circuit of the current layer needs to wait until the arithmetic circuit of the next layer is free before outputting the output result to the arithmetic circuit of the next layer. Using the above implementation manner, overall efficiency of the accelerator is low, design requirements for the circuit are high, and flexibility is insufficient.

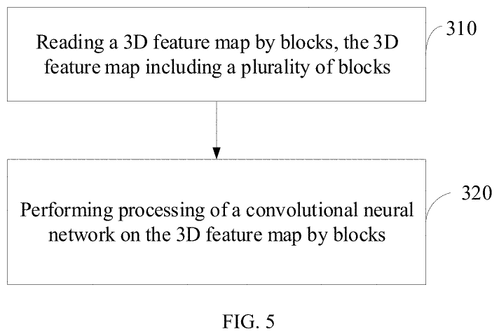

Therefore, the 3D feature map of a convolutional neural network can be divided into a plurality of blocks. The 3D feature map can be processed based on the convolutional neural network by blocks. A specific execution process is shown in FIG. 5. The method shown in FIG. 5 may be implemented by a processing device. The processing device may optionally include the processor 100 shown in FIG. 4.

Optionally, the processing device may include an arithmetic circuit of each layer. The arithmetic circuit of each layer may perform processing of a corresponding layer according to the method shown in FIG. 5.

Alternatively, the processing device may include a control circuit and an arithmetic circuit of each layer. The control circuit may control the arithmetic circuit of each layer to perform processing of the corresponding layer according to the method shown in FIG. 5.

Alternatively, the processing device may include a control unit but not an arithmetic circuit. In 320, performing processing of at least two layers based on a convolutional neural network may refer to controlling the arithmetic circuit of each layer to perform processing.

Optionally, the processing device in the embodiments of the present application may be implemented by FPGA or ASIC. Because FPGA or ASIC is an application-specific integrated circuit, it can implement specific functions through custom hardware accelerators, and the processing is more efficient.

The processing device is not limited in the embodiments of the present application.

In 310, the processing device may read the 3D feature map by blocks. The 3D feature map includes a plurality of blocks.

Reading the 3D feature map by blocks can be reading data included in each block from the off-chip memory (data of read blocks can be stored to the first on-chip memory), or reading data included in each block from the first on-chip memory. The first on-chip memory in the embodiments of the present application may be a SRAM.

The first on-chip memory can be two-dimensional. For example, the storage format can be 4096×128 b. Storage of 3D feature maps (e.g., reading data that has not been processed by a convolutional neural network or intermediate output results obtained after processing) is an expansion in 2D space. Specifically, an address can be introduced for each feature to achieve access to 3D space.

In the embodiments of the present application, when number of features is 1, the storage of the 3D feature map can be stored in a 2D manner.

The 3D feature map may not have been processed by any layer of hidden layers of a convolutional neural network, or it may have been processed by at least one layer of the hidden layer.

In 320, the processing device may perform processing of the convolutional neural network on the 3D feature map by blocks.

Optionally, processing performed on the 3D feature map by blocks may be respectively processing a same layer by blocks.

There may be one arithmetic circuit, and the arithmetic circuit can process a plurality of blocks in sequence, i.e., after one block is processed, a next block can be processed. Alternatively, there may also be at least two arithmetic circuits to perform processing of the plurality of blocks respectively.

Optionally, In the embodiments of the present application, at least two layers of a convolutional neural network can be processed on the 3D feature map by blocks.

For processing each layer, there may be one arithmetic circuit or a plurality of arithmetic circuits. The plurality of arithmetic circuits can perform processing of the layer in parallel.

In the embodiments of the present application, a 3D feature map is read by blocks and processed by a convolutional neural network, which can realize processing on the 3D feature map when on-chip storage resources or processing capabilities are insufficient.

For example, if storage resources of the first on-chip memory are insufficient, the 3D feature map can be read by blocks and the read blocks are stored to the first on-chip memory. Only a single block of input data needs to be stored on the chip. Assuming that the 3D feature map is divided into a plurality of blocks in the channel direction, data of part of features of the 3D feature map can be read from the off-chip memory each time, stored on the first on-chip memory, and then processed by convolution or pooling.

For another example, if the processing capacity of a single arithmetic circuit is limited, the single arithmetic circuit can perform computation by blocks.

Optionally, when processing each block, an output result of the current layer is stored to the first on-chip memory until it is read by a next layer.

Specifically, the arithmetic circuits of each layer can store the output results to the first on-chip memory after processing the corresponding layer. The output result is no longer stored from the first on-chip memory to the off-chip memory. An arithmetic circuit of a next layer can read a computation result output by an arithmetic circuit of a previous layer in the first on-chip memory from the first on-chip memory to perform corresponding computations.

For example, arithmetic circuits for convolution processing can store output results of convolutional layer processing to the first on-chip memory by blocks. arithmetic circuits for pooling can read the convolutional layers in the first on-chip memory, store output results and compute the pooling layer by blocks.

One embodiment of the present application proposes that an output result of a current layer can be stored to the first on-chip memory. However, considering that an available storage space of the first on-chip memory is generally small, if an amount of data to be stored is large, a storage cannot be realized.

For example, it is assumed an input data of CNN is a 3D feature map of 224×224×128 with W=224, H=224 and M=128, and hidden layers of the current network include convolutional layers and pooling layers.

Assuming that number of convolution kernels is 128, a size of the convolution kernel is 3×3×128, a stride is 1, and there is no element padding when processing the convolution layer, then an output result of the convolution is a 3D feature map of 222×222×128. Assuming that a maximum pooling with a window of 3×3 is required, a stride is 1, and there is no element padding when the pooling layers are processed, then output results of the pooling is a 3D feature map of 220×220×128.

According to the above convolution and pooling computations, it is necessary to read 224×224×128 data from the memory and output 220×220×128 data to the memory.

For the above steps, storage capacities in Table 1 below can be obtained.

TABLE 1

| | |
|---|---|
| Feature input | 224 × 224 × 128 = 6272 KB |
| Convolutional layer output | 224 × 222 (16 B aligned, 222 rounded |
| | up to 224) × 128 = 6216 KB |
| Output of the pooling layer | 224 × 220 (16 B aligned, 220 rounded |
| | up to 224) × 128 = 6160 KB |
| Convolutional layer parameters | 3 × 3 × 128 × 128 = 144 KB |

In the above Table 1, “16 B aligned, 222 rounded up to 224” or “16 B aligned, 220 rounded up to 224” means that in a storage process, every 16 numbers are packed and stored with a storage address. Storage data of each row needs to be stored in multiples of 16. When data of each row is not enough, some invalid data can be padded to make data of a row a multiple of 16. For example, value of invalid data can be 0 to 255 and so on. The row mentioned here is data contained in a 2D feature map when H=1. Amount of data in a row can be equal to W.

The above description is made by taking every 16 pieces of data packaged and stored as an example. Other amounts of data may also be packaged and stored. For example, every 8 pieces of data may be packaged and stored. Amount of data packaged and stored each time may be determined based on storage resources.

It can be seen from the above computation results that, except for parameters of the convolutional layer, nothing else can be stored in the on-chip memory with available space of 512 KB.

Therefore, in the embodiments of the present application, a processing of at least two layers of a convolutional neural network is performed on the 3D feature map by blocks. When processing each block, an output result of a current layer is stored to the first on-chip memory for processing a next layer, thereby realizing a processing of the 3D feature map when on-chip storage resources or processing capabilities are not insufficient, avoiding repeatedly reading data from off-chip storage resources and avoid occupying excessive system bandwidth.

And further, use of the first on-chip memory to store output results can avoid that, when a previous-stage arithmetic circuit (e.g., convolutional layer arithmetic circuit) needs to wait for a next-stage arithmetic circuit (e.g., pooling layer arithmetic circuit) to be idle before outputting an output result of the previous-stage arithmetic circuit to the next-stage arithmetic circuit, thereby avoiding insufficient flexibility of circuits.

Reading by blocks and processing the convolutional neural network does not mean that when reading data, data of a block needs to be read at a time, and then be processed. Considering processing performance of an arithmetic circuit of each layer, data in a single block can be read and processed a plurality of times when processing one of layers, or data in a single block can be processed in parallel by a plurality of arithmetic circuits when processing one of layers.

Processing of the convolutional neural network may not be processing all by blocks. For example, one layer in the convolutional neural network is processed by blocks. Processing of other layers can be non-block processing (i.e., the 3D feature map is processed without dividing blocks). The non-block processing of other layers may be before processing by blocks or after processing by blocks.

For example, the convolutional layer and the pooling layer can be processed by blocks. The activation layer and the fully connected layer can be processed by non-blocks.

For another example, the convolutional layer, the pooling layer, and the activation layer are processed by blocks, while the fully connected layer may be processed by non-blocks.

Optionally, in the embodiments of the present application, according to available storage capacity of the first on-chip memory and/or parameters used in a processing of each layer of a convolutional neural network, the 3D feature map may be divided into a plurality of blocks, so that an output result obtained by processing each block can be stored to the first on-chip memory.

The parameters used in the processing of each layer of the convolutional neural network can be regarded as parameters that have an impact on size of the output result when performing computations on each layer.

For example, for the convolutional layer, the parameters can be a size of the convolution kernel and a sliding step length of the convolution kernel, etc. For the pooling layer, the parameters can be a pooling method, a pooling window size, and a sliding step length of the pooling window.

In the embodiments of the present application, the 3D feature map is divided into a plurality of blocks. When the processing device is implemented, the specific implementation operation may determine size of each block and read data from the 3D feature map according to the determined size.

For example, according to available storage capacity of the first on-chip memory and/or parameters adopted by each layer of a convolutional neural network, execution of a main processing device in the embodiments of the present application may determine size of each of the plurality of blocks. When the processing device includes the processor 100 as shown in FIG. 4, the determining operation may be implemented by the control circuit 110.

The processing device in the embodiments of the present application may not have a substantial block division operation, and only performs reading and computation by blocks when reading and computing.

Optionally, in the embodiments of the present application, size and reading order of each block may be preset on the processing device. According to the preset size and the reading order, the processing device can directly read the 3D feature map by blocks. The block size and the reading order may be determined by a main body performing the preset operation according to available storage capacity of the first on-chip memory and/or parameters adopted by each layer of a convolutional neural network.

Optionally, if available storage resources of the first on-chip memory are sufficient to store output results of the 3D feature map operations at each layer, the 3D feature map may not be divided into blocks.

For example, for global pooling, compared to maximum pooling, a feature usually has only one data output, i.e., storage capacity of an output result of global pooling is much smaller than storage capacity of an output result of maximum pooling. Accordingly, if output of a processing result of the convolutional layer adopted by a convolutional neural network is also very small, the first on-chip memory can store the output result when the 3D feature map is not divided. Then the 3D feature map may not be divided. The 3D feature map can be directly processed by the convolutional neural network as a whole.

In addition, as shown in Table 1, since a data volume of parameters of the convolutional layer (e.g., convolution kernel, etc.) is less than a data volume of an input feature, Input data of the feature can be reused as much as possible, i.e., a computation result of the input data of the feature can be stored to the first on-chip memory. There is no need to repeatedly store and read intermediate results to and from the off-chip memory. Parameters of the convolutional layer can be stored to an off-chip memory and read repeatedly. If storage spaces of the first on-chip storage period is sufficient, the parameters of the convolutional layer can also be stored to the first on-chip memory.

Optionally, the off-chip memory mentioned in the embodiments of the present application may be a double data rate synchronous dynamic random-access memory (DDR) or the like.

Optionally, in the embodiments of the present application, sizes of the plurality of blocks into which the 3D feature map is divided may be same or may not be completely same.

For example, according to available storage capacity of the first on-chip memory, size of a largest block can be determined. A convolutional neural network is sequentially read and processed according to the largest block until the last block is read and processed. Size of can be smaller than size of the largest block.

For example, according to available storage capacity of the first on-chip memory, size of the largest block can be determined. Then according to the size of the largest block, the 3D feature map is divided equally. Size of each block after division may be smaller than the size of the determined largest block.

Optionally, in the embodiments of the present application, the 3D feature map may be divided into a plurality of blocks in at least one of a width direction, a height direction, and a channel direction.

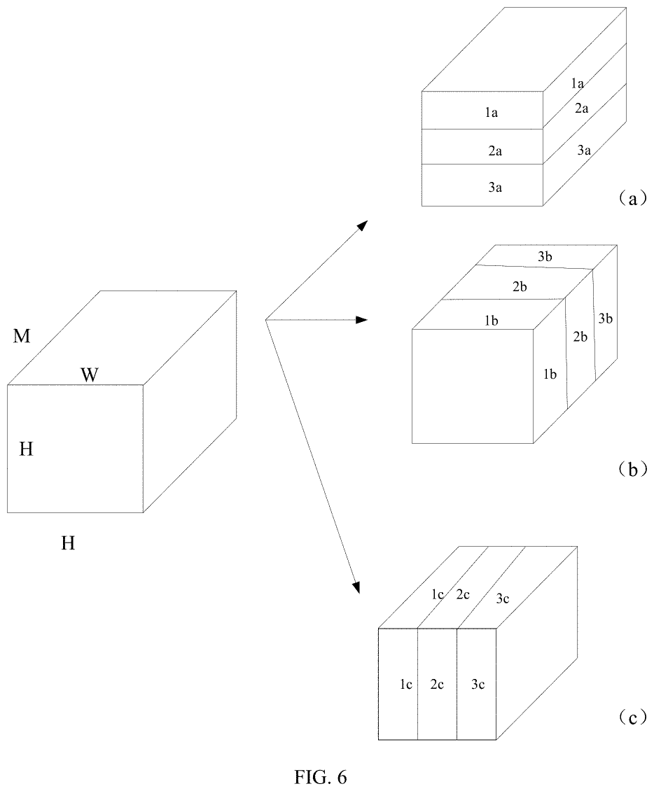

For example, as shown in FIG. 6, a 3D feature map with a size of W×H×M can be divided in the height direction. Specifically, 3 blocks can be obtained as shown in FIG. 6(a). Or the 3D feature map with the size of W×H×M can be divided in the channel direction M. Specifically, 3 blocks can be obtained as shown in FIG. 6(b). Or the 3D feature map with the size of W×H×M can be divided in the width direction. Specifically, 3 blocks can be obtained as shown in FIG. 6(c).

In the above, FIG. 6 shows that a block is divided in one direction, and the block can also be divided in at least two directions.

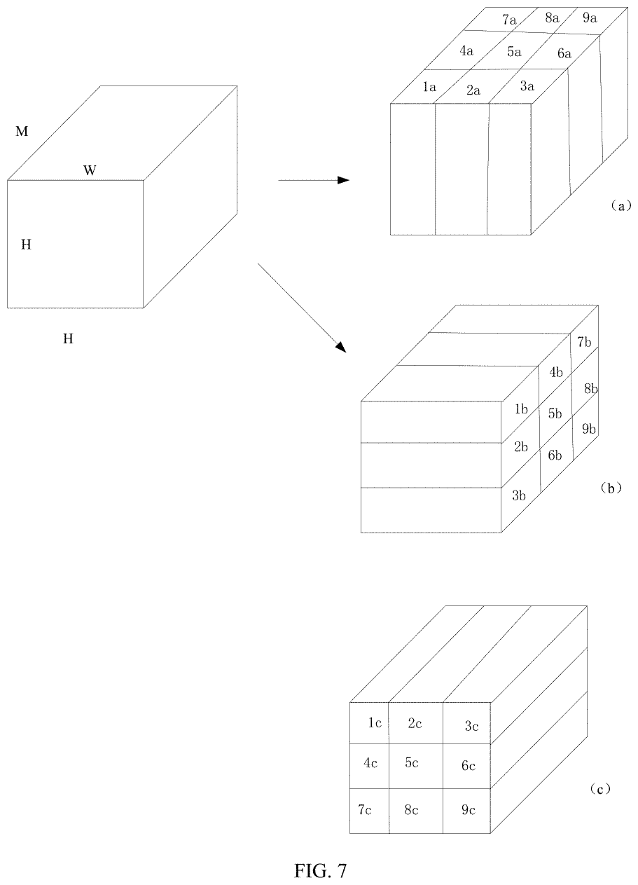

For example, as shown in FIG. 7(a), the 3D feature map can be divided in the width direction and the channel direction, and 9 blocks can be obtained. Or, as shown in FIG. 7(b), the 3D feature map can be divided in the height direction and the channel direction, and 9 blocks can be obtained. Or, as shown in FIG. 7(c), the 3D feature map can be divided in the width direction and the height direction, and 9 blocks can be obtained.

Optionally, in the embodiments of the present application, read addresses and write addresses of a plurality of blocks in a same layer may have a certain relationship. For example, the read addresses and the write addresses may be continuous in storage space, or may occupy a same storage space. The relationship can be preset on a processing device. When input data of one of the blocks of a layer is read, a read address of the block can be obtained from a read address of a block on a same layer. Or when output data of one of the blocks of a layer is written, a write address of the block can be obtained from a write address of a block on a same layer.

For example, after output data of one block processed by the convolutional layer is written, according to a write address of the output data of the one block, a write address of output data of the convolutional layer of another block can be determined.

For another example, after input data of a pooling layer of one block is read, according to a read address of the input data of the pooling layer of the one block, a read address of the input data of the pooling layer of another block can be determined.

Optionally, in the embodiments of the present application, an output result of a current layer can be stored to the first on-chip memory by covering data that has been read during a processing of a convolutional neural network.

In other words, in a process of the convolutional neural network, an on-chip cache can be recycled, which can improve utilization of the on-chip cache.

A processing device can determine a storage address of data that has been read and store an output result of a current layer in the storage address. The storage address may be a physical address and may include a start address and an end address.

As an example, data read by the current layer of a first block may be overwritten by output result of the current layer of the first block. The “first” in the first block is not to limit a processing order of the blocks, but only to distinguish between the blocks.

For example, after data of the first block is input to the first on-chip memory, an arithmetic circuit for convolution processing can read data input in the first on-chip memory, and then perform convolution processing. After the convolution processing is performed, the arithmetic circuit for convolution processing can overwrite at least part of data in a first block of the first on-chip memory that has been read to store a convolution processing result. An arithmetic circuit for pooling processing can read a convolution processing result, perform pooling processing, and overwrite the convolution processing result that has been read with an output result of the pooling processing.

As a processing of a convolutional neural network progresses, on-chip storage spaces required for intermediate output results corresponding to each block may become smaller and smaller. Extra storage spaces can be used to store other data, such as data of other blocks.

In order to improve efficiency of the convolutional neural network, parallel processing of a plurality of processing lines (pipelines) can be used.

A processing of each block can be called a processing line. The parallel processing of the plurality of processing lines means that there can be at least two blocks being processed at a same time.

The parallel processing of the plurality of processing lines does not mean that the processing actions of the plurality of processing lines must be same. Processing times of at least two processing lines processed in parallel may only partially overlap.

Optionally, in the embodiments of the present application, an output result of the current layer of a first block overwrites data that has been read in a second block (another block other than the first block).

In other words, when one block of the 3D feature map is processed, an output result of the one block can overwrite data that has been read in other blocks in the first on-chip memory.

In one implementation manner, and output result of an (i+1)th layer of a first block overwrite an output result of an ith layer of a second block in the first on-chip memory. The output result of the ith layer of the second block is data that has been read. A convolutional neural network includes n layers, and a value of i ranges from 1 to n−1.

In a processing of a convolutional neural network, time used for reading input data of the (i+1)th layer from the first on-chip memory+computation time of the (i+1)th layer+time used for writing output data of the (i+1)th layer into the first on-chip memory≤time used for reading input data of the ith layer from the first on-chip memory+computation time of the ith layer+time used for writing output data of the ith layer into the first on-chip memory.

For example, in order to realize a parallel processing of two processing lines, output results of two blocks are stored to the first on-chip memory. A pooling process of a first block can be synchronized with a convolution process of a second block. After the pooling process of the first block is completed, an output result of the pooling process can be overwritten with an output result of the convolution process of the second block to be stored to the first on-chip memory. The output result of the pooling process of the first block can be output from the first on-chip memory to the off-chip memory. In the storage location for storing the output result of the pooling process of the first block, the output result of the convolution process of the second block is stored to the first on-chip memory.

Computation capability of pooling can match computation time of convolution, i.e., in system design, the following conditions can be set:

time used for reading input data of a pooling layer from the first on-chip memory+time used for pooling computation+time used for writing output data of a pooling layer to the first on-chip memory≤time used for reading input data of a convolutional layer from the first on-chip memory+time used for convolution computation+time used for writing output data of a convolutional layer into the first on-chip memory.

The following takes a 3D feature map with input data of the convolution layer of CNN of W=224, H=224 and M=128 as an example for description. A block mentioned below is represented by a way of W×H×M. A division mode of the block can be a division in a height direction, which is similar to a division mode shown in FIG. 6(a).

First, the input block for convolution processing is 224×6×128, and number of convolution kernels is 128. A size of the convolution kernel can be 3×3×128 with a stride of 1. A size of a first block output after convolution processing is 222×4×128. A size that needs to be stored to the first on-chip memory is 224×4×128=112 KB. A subsequent second block can further input 4 rows of data and combine last two rows of the data of the first block to obtain an output result of a convolution of the second block, i.e., a size of 224×4×128=112 KB. Then the output result of the convolution of the second block is 112 KB. A convolution processing result of the two blocks stored to the first on-chip memory is 224. A pooling layer can read the convolution result of the first block. A sliding window size of the pooling layer is 3×3, and a stride is 1. Then a pooling result of the first block can be written into a storage space of the convolution result of the first block, i.e., the storage space of the convolution result of a 6-line convolution process is used to store a processing result of a 4-line pooling process, and then the pooling result of the first block is written from the first on-chip memory to an off-chip memory.

In another implementation manner, for output, an output result of an ith layer of a first block overwrite an output result of the ith layer of another block in the first on-chip memory. The output result of the ith layer of the another block is data that has been read by an (i+1)th layer or the data that has been output to the off-chip memory. A convolutional neural network includes n layers, and the value of i ranges from 1 to n−1.

For input, an input data of the ith layer of the first block covers an input data of the ith layer of the another block in the first on-chip memory. The input data of the ith layer of the another block is data that has been read by the ith layer. The convolutional neural network includes n layers, and the value of i ranges from 1 to n−1.

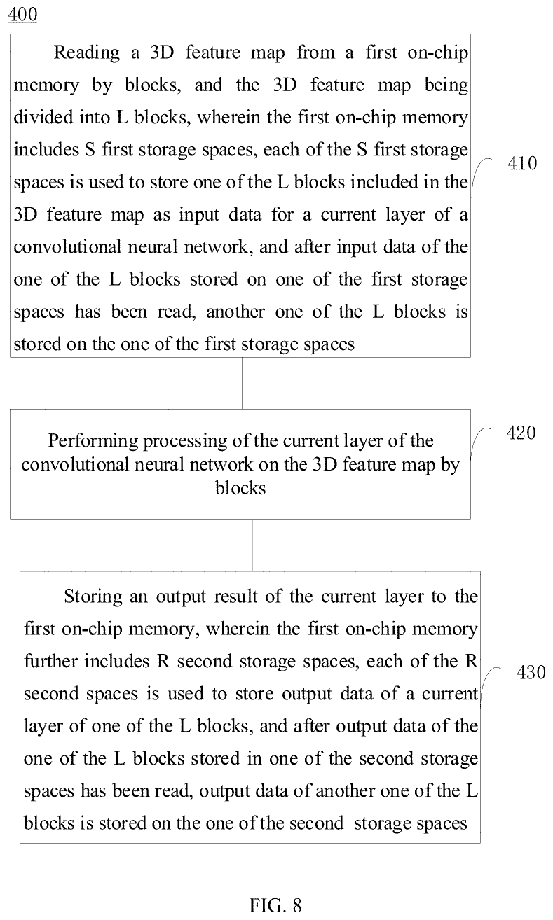

Optionally, the first on-chip memory simultaneously stores input data and/or output data of a same layer of at least two blocks. A specific implementation of a convolutional neural network may be a method 400 shown in FIG. 8. The method 400 may be implemented by a processing device.

In 410, a 3D feature map is read from a first on-chip memory by blocks, the 3D feature map including L blocks. The first on-chip memory includes S first storage spaces. Each of the S first storage spaces is used to store input data of a current layer of one of the L blocks included in the 3D feature map. After the input data of the one of the L blocks stored on one of the first storage spaces is read, input data of the other one of the L blocks on the one of the first storage space is stored.

The input data of the current layer stored in the S first storage spaces may be read from an on-chip memory. The current layer may optionally be a first layer processed by the convolutional neural network.

Alternatively, input data of the current layer stored in the S first storage spaces may be output data processed by a previous layer.

In 420, processing of the current layer of the convolutional neural network is performed on the 3D feature map by blocks.

In 430, an output result of the current layer is stored to the first on-chip memory. The first on-chip memory further includes R second storage spaces. Each of the R second storage spaces is used to store output data of a current layer of one of the L blocks. After the output data of the one of the L blocks stored in one of the second storage spaces has been read, output data of another one of the L blocks is stored on the one of the second storage spaces.

The L, the S, and the R are integers greater than or equal to 2, and the S and the R are less than the L.

Optionally, in the embodiments of the present application, in the implementation manner, number of arithmetic circuits in the current layer can be less than S, and further can be less than R. For example, number of arithmetic circuits is one.

Optionally, in the embodiments of the present application, S may be equal to R.

Alternatively, S is not equal to R.

For example, data stored in the S first storage spaces is used as input data of a convolutional layer. data stored in the R second storage space is output data of the convolutional layer and output data of the pooling layer. If number of arithmetic circuits in the pooling layer are enough and/or computation capabilities of the arithmetic circuits are strong, and the data in the R second storage spaces can be quickly read by the arithmetic circuits of the pooling layer, R can be less than S.

Optionally, in an implementation manner shown in FIG. 8, dividing directions of the blocks may be a width direction and/or a height direction, excluding a channel direction. A block can also be divided into a plurality of sub-blocks in the channel direction.

Optionally, in the embodiments of the present application, when a convolutional neural network includes at least two layers of processing, processing of each layer may correspond to a first storage space and a second storage space, i.e., storage spaces corresponding to different layers for storing input data are not multiplexed. Storage spaces corresponding to different layers for storing output data are not multiplexed at all. However, a first storage space of a current layer is used as a second storage space of a previous layer, and a second storage space of the current layer is used as a first storage space of a next layer.

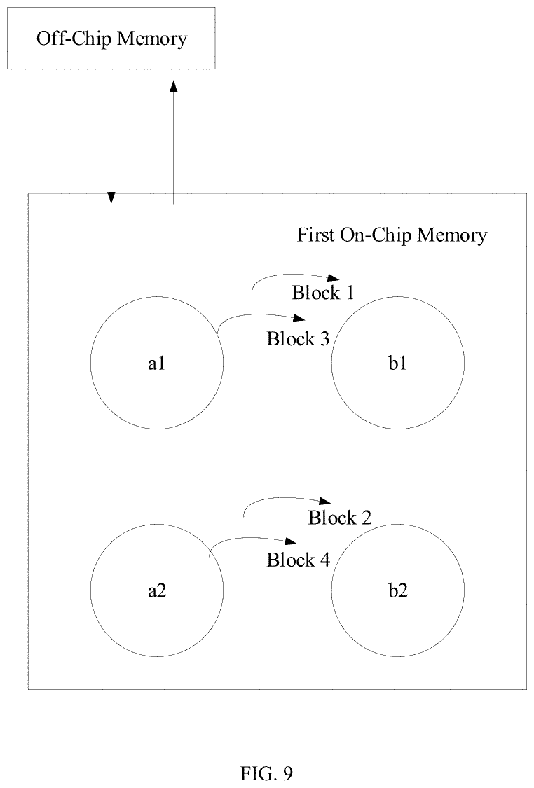

For example, as shown in FIG. 9, a first on-chip memory includes storage spaces a1, a2, b1, and b2. In the storage spaces a1 and a2, input data for convolution processing (other processing such as pooling processing is also applicable, input data of convolution processing can be read from an off-chip memory, and input data of pooling processing can be output data of convolution processing) of the block 1 and block 2 are stored. Arithmetic circuits used for convolution processing performs convolution operation on block 1 and block 2 respectively, and store output results of convolution processing of the block 1 and block 2 in the storage spaces b1 and b2 respectively for processing the pooling layer. When a convolution processing is performed, input data of the block 1 can be first read for convolution processing. After a convolution processing of the block 1 is completed, the arithmetic circuits can directly read the data of the block 2 from the storage space a2 without waiting and perform convolution processing. After the input data of block 1 is read, input data for convolution processing of the block 3 can be stored in the storage space a1 for the arithmetic circuits to read the data of the block 3 for convolution processing after convolution processing the block 2 is completed. Similarly, after input data of the block 2 is read, input data of the block 4 can be stored in a2.

The above example assumes that the convolution processing of one block does not need to use input data of other blocks as an example. In the embodiments of the present application, processing of a current layer of a block can also use input data of other blocks. The first on-chip memory simultaneously stores input data of a same layer of at least three blocks and/or output data of the same layer of the at least three blocks.

Specifically, the above S and/or R may be greater than or equal to 3. For example, S first storage spaces are used to store input data of the convolutional layer. When the convolutional layer processes one of the blocks, data of a previous block needs to be used. S can be greater than or equal to 3. For example, R second storage spaces are used to store output data of the convolutional layer, and the output data can be used for processing the pooling layer. When the pooling layer processes one of the blocks, the data of the previous block needs to be used, then R can be greater than or equal to 3

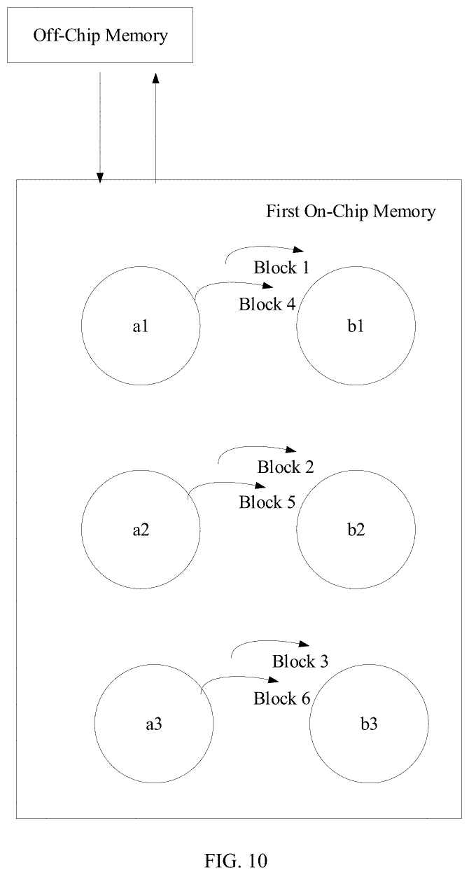

For example, as shown in FIG. 10, a first on-chip memory includes storage spaces a1, a2, a3, b1, b2, and b3. In storage spaces a1, a2 and a3, input data for convolution processing (other processing such as pooling processing is also applicable, input data of convolution processing can be read from an off-chip memory, and input data of pooling processing can be output data of convolution processing) of the block 1, block 2 and block 3 are stored. Arithmetic circuits used for convolution processing performs convolution operation on block 1, block 2 and block 3 respectively. The output results of convolution processing of the block 1, block 2 and block 3 are stored in the storage spaces b1, b2 and b3 respectively for processing the pooling layer. When a convolution processing is performed, input data of the block 1 can be first read for convolution processing. After a convolution processing of the block 1 is completed, the arithmetic circuits can directly read the data of the block 2 from the storage space a2 without waiting and perform convolution processing. After a convolution processing of the block 2 is completed, the arithmetic circuits can directly read the data of the block 3 from the storage space a3 without waiting and perform convolution processing. Since the processing of the block 2 requires the data of the block 1, even if the convolution processing of the block 1 is completed, the data of the block 1 needs to be stored in the storage space a1. After the data of convolution processing of the block 2 is read, data of the block 4 can be stored in the storage space a1. Similarly, after data of a convolution processing of the block 3 is read, data of the block 5 can be stored in the storage space a2. After data of a convolution processing of the block 4 is read, data of the block 6 can be stored in the storage space a3. After the convolution processing of the block 2 is completed, if there is no storage space a3, since the data in the storage space a1 is released late, the arithmetic circuits needs to wait for the data of the block 1 to be released and store data of another block before the arithmetic circuits can continue to perform computations. Therefore, at least three storage spaces are required to store input data, and at least three storage spaces are required to store output data.

As described in the above example, in the embodiments of the present application, data of a block being read completely may mean that the data of the block does not need to be read again in a processing of any block in a current layer.

For example, if the data of the block does not need be used for processing the current layer for another block, after the current layer reads all the data of the block for processing the block, the data of the block can be considered to be completely read.

For example, if the data of the block needs to be used for processing the current layer for another block, after the current layer reads all the data of the block for processing the block and reads at least part of the data of the block for processing the another block, the data of the block can be considered to be completely read.

Therefore, in the embodiments of the present application, a first on-chip memory simultaneously stores input data of a same layer of at least two blocks, which can realize pipeline work, i.e., arithmetic circuits and storage spaces in the system can work efficiently without waiting.

Optionally, in the embodiments of the present application, time used for reading input data of the (i+1)th layer from the first on-chip memory+computation time of the (i+1)th layer+time used for writing output data of the (i+1)th layer into the first on-chip memory time used for reading input data of the ith layer from the first on-chip memory+computation time of the ith layer+time used for writing output data of the ith layer into the first on-chip memory. Sizes of each block are optionally same or different, which are not limited herein. Computation speeds of large blocks can be increased.

For example, in order to ensure that when data output by convolution processing can overwrite data of other blocks, the data of the other blocks has completed pooling operations, the following conditions can be set:

time used for reading input data of a pooling layer from the first on-chip memory+time used for pooling computation+time used for writing output data of a pooling layer to the first on-chip memory≤time used for reading input data of a convolutional layer from the first on-chip memory+time used for convolution computation+time used for writing output data of a convolutional layer into the first on-chip memory.

Regarding how to store output results of each layer, in addition to the above implementation manners, the embodiments of the present application may also have other implementation manners.

For example, processing times of a plurality of blocks is completely synchronized. There can be a plurality of storage spaces for storing data of each block. An output result of a current layer of a block overwrites data read by the current layer of the block.

Optionally, in the embodiments of the present application, a processing device may include a plurality of arithmetic circuits. Blocks to be processed by each arithmetic circuit and a processing order can be preset on the processing device, as well as a storage mode of output results of each arithmetic circuit, etc.

Optionally, certain rules can be preset on the processing device, and data storage can be performed according to the certain rules, or the processing device can detect storage spaces of the first on-chip memory in real time and store data according to a detection result.

Optionally, in the embodiments of the present application, processing instructions of each layer may have a dependency relationship, and the dependency relationship may be a processing sequence dependency relationship.

For example, a neural network needs to perform C1, C2, C3, P1 and C4 processing (C is convolution processing, P is pooling processing). P1 processing needs to wait for a completion of C1 processing and reading, so an output result of P1 processing can be stored in a storage space of C1 processing. C4 processing needs to wait for P1 processing and reading to be completed, so an output results of C4 processing can be stored in a storage space of P1 processing.

Therefore, in the embodiments of the present application, a compiler (e.g., can be implemented by the control circuit 110 shown in FIG. 4) can record the dependency relationship between instructions, so as to prevent stepping during storage, i.e., to avoid overwriting unread data with new data.

Optionally, in the embodiments of the present application, when one layer of a convolutional neural network is processed on a block of a 3D feature map, an output result of a processing of the layer may be stored to the first on-chip memory for processing a next layer. If the output result is required in addition to the processing of the next layer, and there are other operations (e.g., processing of layers after the next layer of the current convolutional neural network or other convolutional neural networks) that need to use the output result, the output result can be stored to an off-chip memory. When the other operations are executed, the output result can be read from the off-chip memory again to the first on-chip memory for the other operations.

After the next layer reads the output result of the current layer in the first on-chip memory, the output result can be read into the off-chip memory, and the output result can be deleted from the first on-chip memory (specifically can be overwritten by other data, such as an output result of the next layer). It can also be that when the next layer has not read the output result of the current layer from the first on-chip memory, the output result of the current layer is stored to the off-chip memory. After the next layer reads the output result of the current layer in the first on-chip memory, the output result can be deleted from the first on-chip memory (specifically can be overwritten by other data, such as an output result of the next layer).

If there are no other operations that need to use the output result of the current layer except for processing the next layer, the output result of the current layer can be stored to the first on-chip memory instead of the off-chip memory.

Optionally, in the embodiments of the application, when data used in the processing for a first block is also required to be processed for a second block (another block other than the first block), the data can be stored to the first on-chip memory, until the data is used to process the second block.

The data may include an integer number of whole rows of data. The manner can be used when the 3D feature map is not divided into two or more blocks in a row direction (i.e., in the width direction). For example, the block division mode can be as shown in FIGS. 6(a) and 6(b).

In the embodiments of the present application, data used by two blocks can be regarded as data belonging to a previous block and not a next block. Alternatively, data cached in a row can also be regarded as belonging to the previous block and another block.

Usually, when data of a single feature of a 3D feature map is stored, data in a same storage address is all or part of the data in one row, excluding two or more rows of data. In the embodiments of the present application, the type of data storage can be called row storage.

For example, when storing, 16 data can be packed and stored in a same storage address. 16 data can be obtained by reading a storage address. Data of a storage address does not span two rows, i.e., data of a storage address does not exceed one row of data.

Assuming that there are 128 data in each row of the 3D feature map, if each storage address can store 16 data, the 128 data can correspond to 8 storage addresses. After the 3D feature map is processed by convolution, each row has 127 data, which can still correspond to 8 storage addresses, but one of the storage addresses can store 7 valid data and 1 invalid data.

When storing data of a single feature, in addition to storing the data in rows, the data can also be stored by columns, i.e., the data in a same storage address is all or part of the data in one column, excluding data in two or more columns.

When data in a first on-chip memory is released (or deleted), the data can be released according to storage addresses. For example, after all 16 data in a storage address has been read, the 16 data can be released.

Optionally, the data mentioned herein may be input data of an input layer, or an output result processed by one layer of a convolutional neural network.

As an example, assuming that a convolution processing is a first processing of the convolutional neural network, when data of one block is read from off-chip, the data in the one block that needs to be processed by convolution of another block can be cached in the first on-chip memory until the another block is processed by convolution. Before the convolution processing, the data in the one block may not be overwritten by other data (e.g., an output result of the first block of convolution processing).

For example, a window for convolution processing is 2×2 and a sliding step of the window is 1. A 3D feature map is divided into blocks according to FIG. 6(a). For each feature, data of last row of a previous block used for convolution processing is used in a next block and is combined with data of first row of the next block for convolution processing. The data of the last row of the previous block can be stored until the data is used for convolution processing of a second block.

For another example, a window for performing convolution processing is 3×3 and a sliding step of the window is 2. A 3D feature map is divided into blocks according to a division mode shown in FIG. 6(a). For each feature, data of last two rows of a previous block used for convolution processing is used in a next block and is combined with data of first row of the next block for convolution processing. The data of the last two rows of the previous block can be stored until the data is used for convolution processing of the second block.

Directions in which the 3D feature map is divided includes at least two directions. When the at least two directions include a height direction, for processing a same layer, a set of all blocks with different width position (also called coordinate) and/or different channel positions (also called coordinate) and a same height position (also called coordinates) can be processed first, then another set of all blocks with a same width position and/or a same channel position and different height positions are processed (a priority traversal of the blocks in a height direction), so that fewer rows of data can be cached.

The following will describe a block division mode and a processing of a convolutional layer shown in FIG. 7(b) as an example.

For example, in a block division mode shown in FIG. 7(b), a convolutional layer processing can be sequentially performed in an order of block 1b, block 4b, block 7b, block 2b, block 5b, block 8b, block 3b, block 6b, and block 9b. When processing the convolutional layer for block 1b, the last at least one row of input data of the block 1b needs to be stored to a first on-chip memory for processing the convolutional layer of the block 2b. When processing the convolutional layer for the block 4b, the last at least one row of input data of the block 4b needs to be stored to the first on-chip memory for processing the convolutional layer of the block 5b. When processing the convolutional layer for the block 7b, the last at least one row of data of the input data of the block 7b needs to be stored to the first on-chip memory for processing the convolutional layer of the block 8b, i.e., after a convolutional layer processing for blocks 1b, 4b, and 7b is completed, it is necessary to store the last at least one row of the input data of the block 1b, the last at least one row of the input data of the block 4b, and the last at least one row of the input data of the block 7b in the first on-chip memory. Then the convolutional layer of the block 2b is processed. The last at least one row of the input data of the block 1b can be read and deleted. However, the last at least one row of the input data of the block 2b need to be stored to the first on-chip memory.

Therefore, in the implementation manner, data of the last at least one row of input data of three blocks need to be stored at a same time.

Or, in a block division mode shown in (b) in FIG. 7, a convolutional layer processing can be sequentially performed in an order of block 1b, block 2b, block 3b, block 4b, block 5b, block 6b, block 7b, block 8b, and block 9b. When processing the convolutional layer for the block 1b, the last at least one row of input data of the block 1b needs to be stored to the first on-chip memory for processing the convolutional layer of the block 2b. Then the convolutional layer for the block 2b is processed. the last at least one row of the input data of the block 1b can be read and deleted. The last at least one row of data of input data of the block 2b can be stored to the first on-chip memory.

Therefore, in the implementation manner (i.e., computations of a block are performed in a manner of a priority traversal of the blocks in a height direction), only the last at least one row of data of a block needs to be stored each time.

Therefore, directions in which a 3D feature map is divided includes at least two directions. When the at least two directions include a height direction, blocks in the height direction can be traversed preferentially, so that fewer rows of data can be cached, and the on-chip storage pressure can be reduced.

Optionally, assuming that the convolution processing is a first processing of a convolutional neural network, a subsequent pooling processing is required. After data of one of the blocks is processed by the convolution processing, an output result can be stored to the first on-chip memory. Then a convolution processing result of the one block can be read all for pooling processing of a first block. However, part of the data of the convolution processing result of the one block still needs to be used for pooling processing of another block. Part of the data can be retained (other parts of the data can be deleted) until the part of the data is used for pooling processing of the another block.

In the embodiments of the present application, data between blocks may also be independent without overlap. Specifically, data used by one block is no longer used by another block.

As an example, when a width of a 3D feature map is divided (e.g., a division mode as shown in FIG. 6(c), since data is stored by rows (i.e., a plurality of data in a single row are packaged and stored in a storage address), if data of one of the blocks includes part of data of a last storage address, a processing of a current layer (e.g., convolutional layer or pooling layer) may not be performed on the last storage address. Then another block can process the current layer of other data or all the data of the last storage address. Alternatively, a first block can perform a processing of the current layer on part or all of the data in the last storage address. A second block does not perform a processing of the current layer on the data of the last storage address.

A single row of data of a single feature of a 3D feature map corresponds to a plurality of storage addresses. A single row of data belongs to at least two blocks, then processed data of a current layer of each of the at least two blocks includes data of an integer number of storage addresses. The processed data of the current layer included in the at least two blocks do not overlap at all. The implementation can simplify a boundary processing, thereby simplifying complexity of the implementation.

Similarly, data mentioned here can be initial input data of a convolutional neural network without any layer processing, or an output result of one of the layers.

For example, when storing, 16 data can be packed and stored in a same storage address. A storage address is read to get 16 data. The data of the storage address does not span two rows, i.e., the data of the storage address does not exceed one row of data. Assuming that there are 128 data in each row of a 3D feature map, the 128 data can correspond to 8 storage addresses. The data to be processed in a current layer of one block may be data with 4 storage addresses, and the data to be processed in a current layer of another block may be data with 4 storage addresses.

Processed data of a current layer of a block is different from the data included in a pre-divided block. For example, assuming that each row of data includes 128 data, when a block is divided, an uneven division mode is used. For example, a first pre-divided block includes 68 data per row. A second pre-divided block includes 60 data per row. When the current layer is actually processed, for the first block, each row can process 64 data, and for the second block, each row can process 64 data.

In the embodiments of the present application, during an initial division of the blocks, it is possible to realize that data of each block only includes data of an integer number of storage addresses, and data included in the at least two blocks does not overlap at all.

The embodiments of the present application are not limited to the above description. When data is stored by rows (i.e., a plurality of data in a single row is packed and stored in a storage address), if a block is divided in a width direction, column data can also be cached. For example, in a division mode of FIG. 6(c), data of the last at least one column of the block 1c can be cached for processing the block 2c. Since the data is stored by rows (i.e., a plurality of data in a single row is packaged and stored in one storage address), for each row, cached data is data of at least one storage address. For example, for a specific row, in data of the block 1c, if data used for processing the block 2c belongs to a storage address, then a total of 16 data in 16 columns can be cached for processing the block 2c. If among the data of the block 1c, the data used for processing the block 2c belongs to two storage addresses, then a total of 32 data in 32 columns can be cached for processing the block 2c.

In addition to storing data in rows, data can also be stored by columns, i.e., data in a same storage address is all or part of the data in one column, excluding data in two or more columns.

In a case where data is stored by columns (i.e., a plurality of data in a single column is packed and stored in a storage address), if a block is divided in a height direction, row data can be cached. For example, in a division mode of FIG. 6(a), data of the last at least one row of the block 1a can be cached for processing the block 2c. Since the data is stored by columns, for each column, cached data is data of at least one storage address. For example, for a specific column, in data of the block 1a, if data used for processing the block 2a belongs to a storage address, then a total of 16 data of 16 rows can be cached for processing the block 2a. If data used for processing the block 2a belongs to two storage addresses, then a total of 32 data of 32 rows can be cached for processing the block 2a.

In a case that data is stored by columns (i.e., a plurality of data in each row is packed and stored into a storage space), if a block is divided in a width direction, column data can be cached. For example, in a division mode of FIG. 6(c), data of the last at least one column (one column or a plurality of columns, number of columns has nothing to do with amount of data in a storage address) of the block 1c can be cached for processing the block 2c.

Based on the above description, when data is stored by rows (i.e., a plurality of data in a single row is packed and stored in a storage address), a block can be divided in a height direction. When data is stored by columns (i.e., a plurality of data in a single column are packed and stored in a storage address), the block can be divided in a width direction to reduce cached data.

Optionally, a division of a 3D feature map may affect a processing order of each data of a convolutional neural network.

As an example, it is assumed that there is a set of arithmetic circuits, which includes a convolution circuit and a pooling circuit. The convolution circuit and the pooling circuit can only process one block each time. A division mode of a block affects an order of data processing.

According to a block division mode shown in FIG. 6(a), when a convolutional neural network is computed, a data processing sequence of the blocks 1a, 2a, and 3a can be followed.

According to a block division mode shown in FIG. 6(b), when a convolutional neural network is computed, a data processing sequence of the blocks 1b, 2b, and 3b can be followed.

According to a block division mode shown in FIG. 6(c), when a convolutional neural network is computed, a data processing sequence of the blocks 1c, 2c, and 3c can be followed.

A data processing sequence can be different for different block division modes.

Optionally, in the embodiments of the present application, when a plurality of blocks are divided in a channel direction of a 3D feature map (e.g., the block division mode shown in FIG. 6(b) and the block division mode shown in FIG. 7(a) and FIG. 7(b)), when convolution computations are performed, because the convolution computations need to accumulate data at a same height position and a same width position on a plurality of features, after the convolution computations on part of the plurality of feature are performed, convolution computation results of the part of the feature can be stored to an on-chip memory (referred to as a second on-chip memory) included in arithmetic circuits. After the convolution computations of all features are completed, the convolution computation results of all features are combined for processing, such as accumulation processing, to obtain an output result of a convolution layer corresponding to a convolution kernel or a 2D feature map and output the output result or the 2D feature map to a first on-chip memory.

Optionally, in the embodiments of the present application, when a 3D feature map is divided in a channel direction, for at least two blocks with a same width position and a same height position, if one or more sub-blocks of the at least two blocks is processed by a convolutional layer first, output results of the convolutional layer processing of the one or more sub-blocks of the blocks can be stored to an on-chip memory (referred to as the second on-chip memory) included in arithmetic circuits. After a convolutional layer processing of the at least two blocks, convolution results of the at least two blocks may be accumulated to obtain an output result of the convolutional layer corresponding to a convolution kernel or a 2D feature map and output the output result or the 2D feature map to a first on-chip memory.

Specifically, output results of the convolutional layer processing of first processed blocks can be stored to the second on-chip memory respectively. After a convolutional layer processing of all the blocks is completed, processing results of the convolutional layer processing of all the blocks are accumulated, and the processing results are output to the first on-chip memory.

Alternatively, output results of the convolutional layer processing of the two blocks processed first can be accumulated and stored to the second on-chip memory. After a convolutional layer processing of another block, a cumulative result obtained last time and an output result of the convolutional layer of the another block can be accumulated and stored to the second on-chip memory, and cumulative results previously stored to the second memory are deleted until a cumulative result accumulates output results of the convolutional layer processing of all the blocks, and output the cumulative result to the first on-chip memory.

For example, in a block division mode shown in FIG. 6(b), after convolution processing results of the blocks 1b and 2b are obtained, the convolution processing results of the blocks 1b and 2b can be stored to the second on-chip memory. After a convolution processing result of the block 3b is obtained, the convolution processing results of the blocks 1b and 2b can be read from the second on-chip memory, and the convolution processing results of the blocks 1b and 2b can be deleted from the second on-chip memory after being read. The convolution processing results of the blocks 1b, 2b, and 3b can be combined, and a final convolution processing result can be output to the first on-chip memory.

Or, in a block division mode shown in FIG. 6(b), after a convolution processing result of the block 1b is obtained, the convolution processing result of the block 1b can be stored to the second on-chip memory. After a convolution processing result of the block 2b is obtained, a cumulative result of the convolution processing result results of the block 1b and the block 2b can be stored to the second on-chip memory, and the convolution processing result of the block 1b stored to the second on-chip memory can be deleted. After a convolution processing result of the block 3b is obtained, the cumulative result of the convolution processing results of the block 1b and the block 2b can be read from the second on-chip memory, and the convolution processing result of the block 1b and block 2b stored to the second on-chip memory can be deleted. The cumulative result of the convolution processing results of the block 1b and the block 2b and the convolution processing result of 3b can be combined, and a final convolution processing result can be output to the first on-chip memory.

For another example, in the block division mode shown in FIG. 7(a), a convolutional layer processing can be sequentially performed in an order of block 1a, block 4a, block 7a, block 2a, block 5a, block 8a, block 3a, block 6a, and block 9a. After a convolution processing result of the block 1a is obtained, the convolution processing result of the block 1a can be stored to the second on-chip memory. After a convolution processing result of the block 4a is obtained, the convolution processing result of the block 4a can be stored to the second on-chip memory. After a convolution processing result of the block 7a is obtained, the convolution processing results of the blocks 1a and 4a can be read from the second on-chip memory. The convolution processing results of the blocks 1a and 4a can be deleted from the second on-chip memory after being read. The convolution processing results of the blocks 1a, 4a, and 7a can be accumulated. A cumulative result of the convolution processing results of the blocks 1a, 4a, and 7a can be output to the first on-chip memory. Similarly, after a convolution processing result of the block 2a is obtained, the convolution processing result of the block 2a can be stored to the second on-chip memory. After a convolution processing result of the block 5a is obtained, the convolution processing result of the block 5a can be stored to the second on-chip memory. After a convolution processing result of the block 8a is obtained, the convolution processing results of the blocks 2a and 5a can be read from the second on-chip memory. The convolution processing results of the blocks 2a and 5a can be deleted from the second on-chip memory after being read. The convolution processing results of the blocks 2a, 5a, and 8a can be accumulated. A cumulative result of the convolution processing results of the blocks 2a, 5a, and 8a can be output to the first on-chip memory. After a convolution processing result of the block 3a is obtained, the convolution processing result of the block 3a can be stored to the second on-chip memory. After a convolution processing result of the block 6a is obtained, the convolution processing result of the block 6a can be stored to the second on-chip memory. After a convolution processing result of the block 9a is obtained, the convolution processing results of the blocks 3a and 6a can be read from the second on-chip memory. The convolution processing results of the blocks 3a and 6a can be deleted from the second on-chip memory after being read. The convolution processing results of the blocks 3a, 6a, and 9a can be accumulated. A cumulative result of the convolution processing results of the blocks 3a, 6a, and 9a can be output to the first on-chip memory.

Or, in a block division mode shown in FIG. 7(a), a convolutional layer processing can be sequentially performed in an order of block 1a, block 4a, block 7a, block 2a, block 5a, block 8a, block 3a, block 6a, and block 9a. After a convolution processing result of the block 1a is obtained, the convolution processing result of the block 1a can be stored to the second on-chip memory. After a convolution processing result of the block 4a is obtained, a cumulative result of the convolution processing results of the block 1a and the block 4a can be stored to the second on-chip memory, and the convolution processing result of the block 1a is deleted. After the convolution processing result of the block 7a is obtained, the cumulative result of the convolution processing results of the blocks 1a and 4a can be read from the second on-chip memory. The cumulative result of the convolution processing results of the blocks 1a and 4a can be deleted from the second on-chip memory after being read. The cumulative convolution processing results of the blocks 1a and 4a and the convolution processing result of the block 7a can be accumulated. A cumulative result of the convolution processing results of the blocks 1a and 4a and 7a can be output to the first on-chip memory. Similarly, after a convolution processing result of the block 2a is obtained, the convolution processing result of the block 2a can be stored to the second on-chip memory. After a convolution processing result of the block 5a is obtained, a cumulative result of the convolution processing results of the block 2a and the block 5a can be stored to the second on-chip memory, and the convolution processing result of the block 2a is deleted. After the convolution processing result of the block 8a is obtained, the cumulative result of the convolution processing results of the blocks 2a and 5a can be read from the second on-chip memory. The cumulative result of the convolution processing results of the blocks 2a and 5a can be deleted from the second on-chip memory after being read. The cumulative convolution processing results of the blocks 2a and 5a and the convolution processing result of the block 8a can be accumulated. A cumulative result of the convolution processing results of the blocks 2a and 5a and 8a can be output to the first on-chip memory. After a convolution processing result of the block 3a is obtained, the convolution processing result of the block 3a can be stored to the second on-chip memory. After a convolution processing result of the block 6a is obtained, a cumulative result of the convolution processing results of the block 3a and the block 6a can be stored to the second on-chip memory, and the convolution processing result of the block 3a can be deleted. After the convolution processing result of the block 9a is obtained, the cumulative result of the convolution processing results of the blocks 3a and 6a can be read from the second on-chip memory. The cumulative result of the convolution processing results of the blocks 3a and 6a can be deleted from the second on-chip memory after being read. The cumulative convolution processing results of the blocks 3a and 6a and the convolution processing result of the block 9a can be accumulated. A cumulative result of the convolution processing results of the blocks 3a and 6a and 9a can be output to the first on-chip memory.

For another example, in the block division mode shown in FIG. 7(a), a convolutional layer processing of the block can be sequentially performed in the order of the block 1a, block 2a, block 3a, block 4a, block 5a, block 6a, block 7a, block 8a, and block 9a. After convolutional layer processing results of the blocks 1a, 2a, 3a, 4a, 5a, and 6a are obtained in sequence, the convolutional layer processing results of the blocks 1a, 2a, 3a, 4a, 5a, and 6a can be respectively stored to the second on-chip memory. After a convolutional layer processing result of the block 7a is obtained, the convolutional layer processing results of the block 1a and the block 4a can be read from the second on-chip memory. The convolutional layer processing results of the block 1a and block 4a can be deleted after being read. The convolutional layer processing results of the blocks 1a, 4a and 7a can be accumulated and a cumulative result of the convolutional layer processing results of the blocks 1a, 4a and 7a can be output to the first on-chip memory. After a convolutional layer processing result of the block 8a is obtained, the convolutional layer processing results of the block 2a and the block 5a can be read from the second on-chip memory. The convolutional layer processing results of the block 2a and block 5a can be deleted after being read. The convolutional layer processing results of the blocks 2a, 5a and 8a can be accumulated and a cumulative result of the convolutional layer processing results of the blocks 2a, 5a and 8a can be output to the first on-chip memory. After a convolutional layer processing result of the block 9a is obtained, the convolutional layer processing results of the block 3a and the block 6a can be read from the second on-chip memory. The convolutional layer processing results of the block 3a and block 6a can be deleted after being read. The convolutional layer processing results of the blocks 3a, 6a and 9a can be accumulated and a cumulative result of the convolutional layer processing results of the blocks 3a, 6a and 9a can be output to the first on-chip memory.

Or, in the block division mode shown in FIG. 7(a), a convolutional layer processing of the block can be sequentially performed in the order of the block 1a, block 2a, block 3a, block 4a, block 5a, block 6a, block 7a, block 8a, and block 9a. After convolutional layer processing results of the blocks 1a, 2a, and 3a are obtained in sequence, the convolutional layer processing results of the blocks 1a, 2a, and 3a can be stored to the second on-chip memory respectively. After a convolutional layer processing result of the block 4a is obtained, the convolutional layer processing results of the blocks 1a and 4a can be accumulated and stored to the second on-chip memory. The convolutional layer processing result of the block 1a can be deleted. After a convolutional layer processing result of the block 5a is obtained, the convolutional layer processing results of the blocks 2a and 5a can be accumulated and stored to the second on-chip memory. The convolutional layer processing result of the block 2a can be deleted. After a convolutional layer processing result of the block 6a is obtained, the convolutional layer processing results of the blocks 3a and 6a can be accumulated and stored to the second on-chip memory. The convolutional layer processing result of the block 3a can be deleted. After a convolutional layer processing result of the block 7a is obtained, a cumulative result of the convolutional layer processing results of the blocks 1a and 4a and the convolutional layer processing results of the blocks 7a can be accumulated and stored to the second on-chip memory. The cumulative result of the convolutional layer processing results of the blocks 1a and 4a can be deleted. After a convolutional layer processing result of the block 8a is obtained, a cumulative result of the convolutional layer processing results of the blocks 2a and 5a and the convolutional layer processing results of the blocks 8a can be accumulated and stored to the second on-chip memory. The cumulative result of the convolutional layer processing results of the blocks 2a and 5a can be deleted. After a convolutional layer processing result of the block 9a is obtained, a cumulative result of the convolutional layer processing results of the blocks 3a and 6a and the convolutional layer processing results of the blocks 9a can be accumulated and stored to the second on-chip memory. The cumulative result of the convolutional layer processing results of the blocks 3a and 6a can be deleted.

As can be seen from the above examples, in accordance with a block division mode (i.e., a block division in both a channel direction and a width direction) shown in FIG. 7(a), when a convolutional layer is processed, if the width direction is traversed first (specifically, all blocks with different height positions and/or different channel positions and a same width position can be processed first, and then other blocks with a same height position and/or a same channel position and different width positions are processed.), convolution processing results of more blocks can be cached in the second on-chip memory, if the channel direction is traversed first (Specifically, all blocks with different height positions and/or different width positions and a same channel positions can be processed first, and then all blocks with the same height position and/or width position and in different channel positions are processed.), convolution processing results of fewer blocks can be cached in the second on-chip memory.

Similarly, in a block division mode (i.e., division of the blocks in both the channel direction and the height direction) shown in FIG. 7(b), when a convolutional layer is processed, if the height direction is traversed first, convolution processing results of more blocks can be cached in the second on-chip memory, if the channel direction is traversed first, convolution processing results of fewer blocks can be cached in the second on-chip memory.

However, as shown above, when a height direction is traversed first, fewer rows of data can be cached in the first on-chip memory.

Therefore, when a block is divided in both a channel direction and a height direction, resources of the second on-chip memory occupied by storages required for accumulation operation for convolution processing, and resources of the first on-chip memory occupied by row cache can be considered comprehensively, to determine whether to traverse the channel direction or the height direction first.

Similarly, when a block is divided in both a channel direction and a width direction, resources of the second on-chip memory occupied by storages required for accumulation operation for convolution processing, and resources of the first on-chip memory occupied by column cache can be considered comprehensively, to determine whether to traverse the channel direction or the width direction first.

Moreover, it can be seen from the above description that storage capacity of the second on-chip memory included in arithmetic circuits can also affect division of a block. For example, if storage capacity of the second on-chip memory is small, the block may not be divided in a channel direction.

In a solution shown in FIG. 8, division directions of a block can be a height direction and/or a width direction, excluding a channel direction. Assuming that a certain block is divided into at least two sub-blocks in the channel direction, a processing of a current layer is a convolutional layer processing, there may be the following two implementation manners.

In one implementation manner, if a convolutional layer processing is performed on one or more sub-blocks of the at least two sub-blocks first, then output results of the convolutional layer processing of the one or more sub-blocks of at least two sub-blocks are respectively stored to a second on-chip memory included in arithmetic circuits. After the convolutional layer processing of the at least two sub-blocks is completed, processing results of the convolutional layer processing of the at least two sub-blocks are accumulated and output to the second storage space.

In another implementation manner, if a convolutional layer processing is performed on one or more sub-blocks of the at least two sub-blocks first, then output results of the convolutional layer processing of the first processed sub-block are first accumulated and stored to a second on-chip memory included in arithmetic circuit. After a convolutional layer processing of another sub-block is completed, a cumulative result obtained last time and an output result of the convolutional layer of the another sub-block are accumulated and stored to the second on-chip memory, the cumulative result previously stored to the second on-chip memory is deleted until a cumulative result has accumulated output results of the convolutional layer processing of the at least two sub-blocks, and the cumulative result is stored to a first on-chip memory.

Optionally, in the embodiments of the present application, when each layer of the convolutional neural network is processed, reading mode of input data (e.g., sliding mode of a sliding window) can affect release of data in a first on-chip memory. The following is based on a premise that data included in a block is released by rows, columns, or storage addresses.

In one implementation manner, assuming that a block is divided in a width direction and not divided in a height direction as shown in FIG. 6(c), at least one column of data of the block 1c needs to be stored to a first on-chip memory for processing the block 2c. When a sliding window is slide, if the sliding is carried out by rows first and by columns then, and a sliding step is 1, after data of one row of the block 2c is traversed, data of a next row needs to be processed and data belonging to the one row in the data of the at least one column needs to be released. When a sliding window is slide, if the sliding is carried out by columns first and then rows, and a sliding step is 1, then data in the at least one column can be traversed first, and the data in the at least one column can be released.

Therefore, when a 3D feature map is divided into blocks in a width direction and not divided into blocks in a height direction, data is read by columns first and then rows.

In the other implementation manner, assuming that a block is divided in a height direction and not divided in a width direction as shown in FIG. 6(a), at least one column of data of the block 1a needs to be stored to a first on-chip memory for processing the block 2a. When a sliding window is slide, if the sliding is carried out by columns first and then rows, and a sliding step is 1, after data of one row of the block 2a is traversed, data of a next row needs to be processed and data belonging to the row in the data of the at least one column needs to be released. When a sliding window is slide, if the sliding is carried out by rows first and by columns then, and a sliding step is 1, then data in the at least one row can be traversed first, and the data in the at least one row can be released.

Therefore, when a 3D feature map is divided into blocks in a height direction and not divided into blocks in a width direction, data is read by columns first and then rows.

As explained above, when data is stored by rows (i.e., a plurality of data in each row is packed and stored into a storage space), the 3D feature map can be divided in a height direction. When data is stored by columns (i.e., a plurality of data in each column is packed and stored into a storage space), the 3D feature map can be divided in a width direction to reduce data cached in a first on-chip memory.

Therefore, in the embodiments of the present application, when input data of each layer of the convolutional neural network is stored by rows, and the input data is read by rows first and by columns then, then a block division mode of the 3D feature map is to divide a block in a height direction and not divide a block in a width direction.

When data is stored by rows, in order to avoid a problem of dividing a block in a width direction and complicated boundary processing (i.e., data of one storage address may respectively belong to two blocks), a block can be divided in a height direction instead of in a width direction.

When input data of each layer of the convolutional neural network is stored by columns, and the input data is read by columns first and then rows, then a block division mode of a 3D feature map is to divide a block in a width direction and not to divide a block in a height direction.

When data is stored by columns, in order to avoid a problem of dividing a block in a height direction and complicated boundary processing (i.e., data of one storage address may belong to two blocks), a block can be divided in a width direction instead of in a height direction.

The above describes that when data of each block of an on-chip memory is released, it can be released by rows, columns or by addresses of a storage space, which is not limited herein. The data of each block can also be released by blocks, i.e., an on-chip storage space can be released after processing a block of data. The release method can reduce control complexity.

Optionally, in the embodiments of the present application, the above block division modes, reading sequences, storage space multiplexing methods, etc. can be preset on a processing device, or can be determined by a processing device according to specific conditions. For example, the above block division modes, reading sequences, storage space multiplexing methods, etc. can be determined based on an actual convolutional neural network used.

For example, when a processing device may include the processor 100 shown in FIG. 4, for a first arithmetic circuit 122 and a second arithmetic circuit 124, size of a block to be read by the arithmetic circuits, data for reading and time for data output can be preset. For a DAM 130, time to read data from a SRAM 140, address to read data, time to write data, and address to write data can be preset. The preset operation may be performed by a control circuit 110 for corresponding operations of the first arithmetic circuit 122 and the second arithmetic circuit 124 and the DAM 130 after the control circuit 110 reads instructions from a DDR. In the embodiments of the present application, the control circuit 110 can also control other circuits in real time.

In the embodiments of the present application, a 3D feature map is read by blocks and processed by a convolutional neural network, which can realize a processing of the 3D feature map when on-chip storage resources or processing capabilities are insufficient.

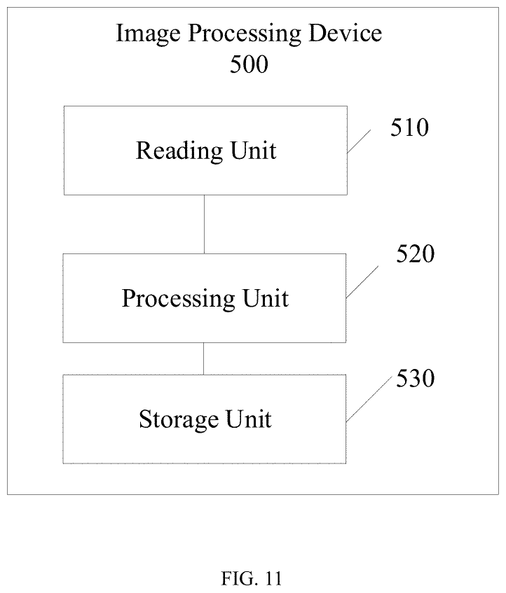

FIG. 11 illustrates a schematic block diagram of an image processing device 500 based on a convolutional neural network consistent with various embodiments of the present application. The device 500 includes:

a reading unit 510, for reading a 3D feature map from a first on-chip memory by blocks, and the 3D feature map being divided into L blocks, wherein the first on-chip memory includes S first storage spaces, each of the S first storage spaces is used to store one of the L blocks included in the 3D feature map as input data of a current layer of a convolutional neural network, and after the input data of the one of the L blocks stored on one of the first storage spaces has been read, another one of the L blocks is stored on the one of the first storage spaces;

a processing unit 520, for performing processing of the current layer of the convolutional neural network on the 3D feature map by blocks; and

a storage unit 530, for storing an output result of the current layer to the first on-chip memory, wherein the first on-chip memory further includes R second storage spaces, each of the R second storage spaces is used to store output data of a current layer of one of the L blocks, and after the output data of the one of the L blocks stored in one of the second storage spaces has been read, output data of another one of the L blocks is stored on the one of the second storage spaces.

The L, the S and the R are integers greater than or equal to 2, and the S and the R are less than the L.

Optionally, in the embodiments of the present application, number of arithmetic circuits included in the processing unit 520 for processing a current layer is less than the S.

Optionally, in the embodiments of the present application, an output result of a current layer is stored to a second storage space until a next layer reads the output result from the second storage space.

Optionally, in the embodiments of the present application, the storage unit 530 is further used for:

in a case that a processing other than processing of a next layer requires to adopt an output result of a current layer, storing the output result of the current layer to an off-chip memory.

Optionally, in the embodiments of the present application, time used for reading input data of the (i+1)th layer from the first on-chip memory+computation time of the (i+1)th layer+time used for writing output data of the (i+1)th layer into the first on-chip memory time used for reading input data of the ith layer from the first on-chip memory+computation time of the ith layer+time used for writing output data of the ith layer into the first on-chip memory, i being an integer from 1 to n−1, and processing of the convolutional neural network includes n layers.

Optionally, in the embodiments of the present application, when input data used for processing a current layer for a first block of the L blocks is also required to be used for processing a current layer for another block, the input data is stored to a first storage space until the input data is used for processing the another block.

Optionally, in the embodiments of the present application, the S is greater than or equal to 3.

Optionally, in the embodiments of the present application, data required for processing on a first block and on another block include an integer number of rows of data; and

when data of a single feature of a 3D feature map is stored, data in a same storage address does not exceed one row of data.

Optionally, in the embodiments of the present application, the plurality of blocks is obtained by dividing a 3D feature map in a height direction without dividing the 3D feature map in a width direction. When each block of the plurality of blocks performs processing of a current layer, input data is read by rows first and by columns then.

Optionally, in the embodiments of the present application, the processing unit 520 is further used for:

in a case that directions for dividing a 3D feature map into blocks include at least two directions and the at least two directions include a height direction, for processing a same layer, first processing a set of all blocks with a same width position and a same channel position and different height positions, then processing another set of all blocks with a same width position and a same channel position and different height position.

Optionally, in the embodiments of the present application, directions in which a 3D feature map is divided into the L blocks include a width direction and/or a height direction.

Optionally, in the embodiments of the present application, a first block of the L blocks is divided into at least two sub-blocks in the channel direction, and the processing of the current layer is a convolutional layer processing.

The processing unit 520 is further used for:

if a convolutional layer processing is performed on one or more sub-blocks of at least two sub-blocks first, respectively storing output results of the one or more sub-blocks of the at least two sub-blocks in a second on-chip memory included in an arithmetic circuit, after a convolutional layer processing of the at least two sub-blocks is completed, accumulating processing results of the convolutional layer processing of the at least two sub-blocks and outputting a cumulative result to a second storage space; or

if a convolutional layer processing is performed on one or more sub-blocks of at least two sub-blocks first, first accumulating and storing output results of the convolutional layer processing of first processed sub-blocks in a second on-chip memory included in arithmetic circuits, after a convolutional layer processing of another sub-block is completed, accumulating and storing the cumulative result obtained last time and an output result of the convolutional layer processing of the another sub-block in the second on-chip memory, deleting a previous cumulative result stored to the second on-chip memory until a cumulative result has accumulated output results of the convolutional layer processing of the at least two sub-blocks, and storing the cumulative result to a first on-chip memory.

Optionally, in the embodiments of the present application, the processing unit 520 is further used for:

according to storage capacity available in a first on-chip memory and/or parameters used for processing a convolutional neural network, determining a size of each of the plurality of blocks.

Optionally, in the embodiments of the present application, a first on-chip memory is a static random-access memory SRAM.

Optionally, in the embodiments of the present application, processing of the convolutional neural network includes convolutional layer processing and pooling layer processing.

Optionally, in the embodiments of the present application, the device 500 is implemented by a FPGA or an ASIC.

The image processing device 500 can implement corresponding operations implemented by a processing device in a method 300 or a method 400. For the sake of brevity, details are not described in the embodiments of the present application.

An image processing device may be implemented by software, by hardware, or by a combination of software and hardware, which is not specifically limited in the embodiments of the present application.

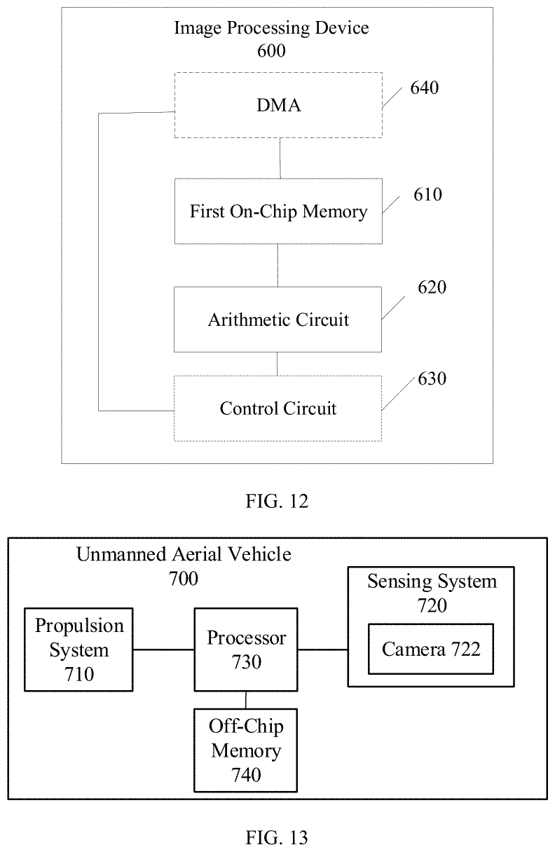

FIG. 12 illustrates a schematic block diagram of an image processing device 600 based on a convolutional neural network consistent with various embodiments of the present application. The device 600 includes a first on-chip memory 610 and an arithmetic circuit 620. The arithmetic circuit 620 is used for:

reading a 3D feature map from the first on-chip memory 610 by blocks; wherein the first on-chip memory 610 includes S first storage spaces, each of the S first storage spaces is used to store one of the L blocks included in the 3D feature map as input data of a current layer of a convolutional neural network, and after the input data of the one of the L blocks stored on one of the first storage spaces has been read, another one of the L blocks is stored on the one of the first storage spaces;

performing processing of the current layer of the convolutional neural network on the 3D feature map by blocks; and

storing an output result of the current layer to the first on-chip memory 610, wherein the first on-chip memory 610 further includes R second storage spaces, each of the R second storage spaces is used to store output data of a current layer of one of the L blocks, and after the output data of the one of the L blocks stored in one of the second storage spaces has been read, output data of another one of the L blocks is stored on the one of the second storage spaces.

The L, the S and the R are integers greater than or equal to 2, and the S and the R are less than the L.

Optionally, in the embodiments of the present application, number of arithmetic circuits included in the arithmetic circuit 620 for processing a current layer is less than the S.

Optionally, in the embodiments of the present application, an output result of a current layer is stored to a second storage space until a next layer reads the output result from the second storage space.

Optionally, in the embodiments of the present application, as shown in FIG. 12, the device 600 further includes a direct memory access DMA 640 for:

in a case that a processing other than processing of a next layer requires to adopt an output result of a current layer, storing the output result of the current layer to an off-chip memory.

Optionally, in the embodiments of the present application, time used for reading input data of the (i+1)th layer from the first on-chip memory 610+computation time of the (i+1)th layer+time used for writing output data of the (i+1)th layer into the first on-chip memory 610≤time used for reading input data of the ith layer from the first on-chip memory 610+computation time of the ith layer+time used for writing output data of the ith layer into the first on-chip memory 610, i being an integer from 1 to n−1, and processing of the convolutional neural network includes n layers.

Optionally, in the embodiments of the present application, when input data used for processing a current layer for a first block of the L blocks is also required to be used for processing a current layer for another block, the input data is stored in a first storage space until the input data is used for processing the another block.

Optionally, in the embodiments of the present application, the S is greater than or equal to 3.

Optionally, in the embodiments of the present application, the data that needs to be used for processing on a first block and on the other block includes data of an integer number of rows; and

when storing the data of a single feature of the 3D feature map, data in a same storage address does not exceed one row of data.

Optionally, in the embodiments of the present application, a plurality of blocks is obtained by dividing a 3D feature map in a height direction without dividing the 3D feature map in a width direction. When performing the processing of the current layer on each block of the plurality of blocks, the input data is read by rows first and by columns then.

Optionally, in the embodiments of the present application, the arithmetic circuit 620 is further used for:

in a case that directions for dividing a 3D feature map into blocks include at least two directions and the at least two directions include a height direction, for processing a same layer, first processing a set of all blocks with a same width position and a same channel position and different height positions, then processing another set of all blocks with a same width position and a same channel position and different height position.

Optionally, in the embodiments of the present application, directions in which a 3D feature map is divided into the L blocks include a width direction and/or a height direction.

Optionally, in the embodiments of the present application, a first block of the L blocks is divided into at least two sub-blocks in the channel direction, and the processing of the current layer is a convolutional layer processing.

The arithmetic circuit 620 is further used for:

if a convolutional layer processing is performed on one or more sub-blocks of at least two sub-blocks first, respectively storing output results of the one or more sub-blocks of the at least two sub-blocks in a second on-chip memory included in an arithmetic circuit, after a convolutional layer processing of the at least two sub-blocks is completed, accumulating processing results of the convolutional layer processing of the at least two sub-blocks and outputting a cumulative result to a second storage space; or

if a convolutional layer processing is performed on one or more sub-blocks of at least two sub-blocks first, first accumulating and storing output results of the convolutional layer processing of first processed sub-blocks in a second on-chip memory included in arithmetic circuits 620, after a convolutional layer processing of another sub-block is completed, accumulating and storing the cumulative result obtained last time and an output result of the convolutional layer processing of the another sub-block in the second on-chip memory, deleting a previous cumulative result stored to the second on-chip memory until a cumulative result has accumulated output results of the convolutional layer processing of the at least two sub-blocks, and storing the cumulative result to the first on-chip memory 610.

Optionally, in the embodiments of the present application, as shown in FIG. 12, the device 600 further includes a control circuit 630 for:

according to storage capacity available in a first on-chip memory 610 and/or parameters used for processing a convolutional neural network, determining a size of each of the plurality of blocks.

Optionally, in the embodiments of the present application, the first on-chip memory 610 is a static random-access memory SRAM.

Optionally, in the embodiments of the present application, processing of the convolutional neural network includes convolutional layer processing and pooling layer processing.

Optionally, in the embodiments of the present application, the device 600 is implemented by a FPGA or an ASIC.

The image processing device 600 can implement corresponding operations implemented by a processing device in the method 300 or the method 400. For the sake of brevity, details are not described herein.

The image processing device 500 may correspond to the processor 100 shown in FIG. 4. For the sake of brevity, details are not described in the embodiments of the present application.

The image processing device 500 or 600 of the embodiments of the present application may be used in a UAV.

FIG. 13 illustrates a schematic diagram of a UAV consistent with various embodiments of the present application. The UAV 700 may include a propulsion system 710, a sensing system 720, and a processor 730.

The propulsion system 710 provides propulsion to the UAV 700 under control of the processor 730. The sensor system 720 includes a camera 722 for taking image frames. The processor 730 is used to generate a 3D feature map based on image frames captured by the camera 722, read the 3D feature map by blocks. The 3D feature map includes a plurality of blocks. The 3D feature map is processed by a convolutional neural network on a block basis, and a processing result of the convolutional neural network can be used for image recognition, so that flight of a UAV can be controlled.

The camera 722 may also be referred to as a camera component, or the camera 722 may be a part of a camera component included in a UAV for acquiring image frames.

The processor 730 may be used to implement image processing methods in the above method embodiments. For the sake of brevity, details are not described in the embodiments of the present application.

Optionally, the processor 730 may be placed in a flight controller. The processor 730 may consist of a plurality of processors. For example, one processor may be used to control flight of a UAV, and one processor may be used to perform processing of the convolutional neural network mentioned in the embodiments of the present application.

Optionally, the UAV may further include an off-chip memory 740, which stores data input to the processor 730, and may store data output by the processor 730.

The above are only specific implementation manners of the present application, but the protection scope of the present application is not limited herein. Those skilled in the art can easily think of changes or substitutions within the technical scope disclosed in the present application, which should be covered by the protection scope of the present application. Therefore, the protection scope of the present application shall be subject to the protection scope of the claims.

What is claimed is:

1. A convolutional neural network-based imaging processing device, comprising a first on-chip memory and an arithmetic circuit configured to:
read a 3D feature map from a first on-chip memory by blocks, the 3D feature map being divided into L blocks, wherein the first on-chip memory includes S first storage spaces, each of the S first storage spaces is used to store one of the L blocks included in the 3D feature map as input data of a current layer of a convolutional neural network, and after the input data of the one of the L blocks stored on one of the first storage spaces has been read, another one of the L blocks is stored on the one of the first storage spaces;
perform processing of the current layer of the convolutional neural network on the 3D feature map by blocks; and
store an output result of the current layer to the first on-chip memory, wherein the first on-chip memory further includes R second storage spaces, each of the R second storage spaces is used to store output data of a current layer of one of the L blocks, and after the output data of the one of the L blocks stored in one of the second storage spaces has been read, output data of another one of the L blocks is stored on the one of the second storage spaces,
wherein the L, the S and the R are integers greater than or equal to 2, and the S and the R are less than the L.

2. The device according to claim 1, wherein number of the arithmetic circuit for performing the processing of the current layer is less than the S.

3. The device according to claim 1, wherein the output result of the current layer is stored to the second storage space until a next layer reads the output result from the second storage space.

4. The device according to claim 3, further comprises a direct memory access DMA configured to:
in a case that a processing other than processing of the next layer requires to adopt the output result of the current layer, store the output result of the current layer to an off-chip memory.

5. The device according to claim 1, wherein a total time added up by time used for reading input data of the (i+1)th layer from the first on-chip memory, computation time of the (i+1)th layer, and time used for writing output data of the (i+1)th layer into the first on-chip memory is less than a total time added up by time used for reading input data of the ith layer from the first on-chip memory, computation time of the ith layer, and time used for writing output data of the ith layer into the first on-chip memory, i being an integer from 1 to n−1, and the processing of the convolutional neural network includes n layers.

6. The device according to claim 1, wherein in response to input data used for processing a current layer for a first block of the L blocks is also required for processing a current layer for another block, the input data is stored in the first storage space until the input data is used for processing the another block.

7. The device according to claim 6, wherein the S is greater than or equal to 3.

8. The device according to claim 6, wherein:
data required for processing on the first block and on the another block include integer number of whole rows of data; and
when storing data of a single feature of the 3D feature map, data in a same storage address does not exceed one row of data.

9. The device according to claim 8, wherein:
the plurality of blocks is obtained by dividing the 3D feature map in a height direction without dividing the 3D feature map in a width direction; and
when performing the processing of the current layer on each block of the plurality of blocks, the input data is read by rows first and by columns then.

10. The device according to claim 8, wherein the arithmetic circuit is further configured to:
in a case that directions for dividing the 3D feature map into blocks include at least two directions and the at least two directions include a height direction, for processing a same layer, first process a set of all blocks with a same width position and a same channel position and different height positions, then process another set of all blocks with a same width position and a same channel position and different height position.

11. The device according to claim 1, wherein directions in which the 3D feature map is divided into the L blocks include a width direction and/or a height direction.

12. The device according to claim 11, wherein:
a first block of the L blocks is divided into at least two sub-blocks in the channel direction, and the processing of the current layer is a convolutional layer processing; and
the arithmetic circuit is further configured to:
in response to that the convolutional layer processing is performed on one or more sub-blocks of the at least two sub-blocks first,
respectively store output results of the one or more sub-blocks of the at least two sub-blocks in the second on-chip memory included in the arithmetic circuit;
after the convolutional layer processing of the at least two sub-blocks is completed, accumulate processing results of the convolutional layer processing of the at least two sub-blocks, to obtain a cumulative result; and
outputting the cumulative result to the second storage space, or
in response to that the convolutional layer processing is performed on one or more sub-blocks of the at least two sub-blocks first,
accumulate output results of the convolutional layer processing of processed sub-blocks of the at least two sub-blocks in the second on-chip memory included in the arithmetic circuit to obtain a first cumulative result,
after a convolutional layer processing of another sub-block is completed,
accumulate the first accumulated result obtained last time and an output result of the convolutional layer processing of the another sub-block to obtain a second cumulative result;
store the second cumulative result to the second on-chip memory,
delete the first cumulative result previously stored to the second on-chip memory until a current cumulative result has accumulated output results of the convolutional layer processing of the at least two sub-blocks, and
store the current cumulative result in the first on-chip memory.

13. The device according to claim 1, further comprising a control circuit configured to:
according to storage capacity available in the first on-chip memory and/or parameters for processing the convolutional neural network, determine a size of each of the plurality of blocks.

14. The device according to claim 1, wherein the first on-chip memory is a SRAM.

15. The device according claim 1, wherein processing of the convolutional neural network includes convolutional layer processing and pooling layer processing.

16. The device according to claim 1, wherein the device is implemented by a field programmable gate array (FPGA) or an application-specific integrated circuit (ASIC).

17. A convolutional neural network-based imaging processing method, comprising:
reading a 3D feature map from a first on-chip memory by blocks, the 3D feature map being divided into L blocks, wherein the first on-chip memory includes S first storage spaces, each of the S first storage spaces is used to store one of the L blocks included in the 3D feature map as input data of a current layer of a convolutional neural network, and after the input data of the one of the L blocks stored on one of the first storage spaces has been read, another one of the L blocks is stored on the one of the first storage spaces;
performing processing of the current layer of the convolutional neural network on the 3D feature map by blocks; and
storing an output result of the current layer to the first on-chip memory, wherein the first on-chip memory further includes R second storage spaces, each of the R second storage spaces is used to store output data of a current layer of one of the L blocks, and after the output data of the one of the L blocks stored in one of the second storage spaces has been read, output data of another one of the L blocks is stored on the one of the second storage spaces,
wherein the L, the S and the R are integers greater than or equal to 2, and the S and the R are less than the L.

18. The method according to claim 17, wherein number of arithmetic circuits for performing the processing of the current layer is less than the S.

19. The method according to claim 17, wherein the output result of the current layer is stored to the second storage space until a next layer reads the output result from the second storage space.

20. The method according to claim 17, further comprising:
in a case that a processing other than processing of the next layer requires to adopt the output result of the current layer, storing the output result of the current layer to an off-chip memory.
